(19) United States
(12) Patent Application Publication
(10) Pub. No.: US 2010/0294438 A1
(43) Pub. Date: Nov. 25, 2010

(54) ROMAN SHADE SYSTEM

(75) Inventors: David A. Kirby, Zionsville, PA (US); James J. Wilson, Nazareth, PA (US)

Correspondence Address: OSTROLENK FABER GERB & SOFFEN, 1180 AVENUE OF THE AMERICAS, NEW YORK, NY, 100368403, US

(73) Assignee: Lutron Electronics Co., Inc., Coopersburg, PA (US)

(21) Appl. No.: 12/784,096

(22) Filed: May 20, 2010

Related U.S. Application Data
(60) Provisional application No. 61/180,538, filed on May 22, 2009.
(60) Provisional application No. 61/240,064, filed on Sep. 4, 2009.

(51) Int. Cl. A47H 5/032; E06B 9/44; A47H 5/02

(52) U.S. Cl. 160/84.04; 160/323.1

(57) ABSTRACT

A shade system comprises a shade fabric, such as a roman shade fabric, a roller tube, at least one wide flexible lift band (i.e., a section of flexible material) windingly received around the roller tube and extending from the roller tube to a bottom end the of the shade fabric, and a plurality of coupling structures for holding the flexible material adjacent to a rear surface of the shade fabric. Each coupling structure is attached to the rear surface of the shade fabric at attachment points that are spaced apart, such that the coupling structures and the shade fabric form openings for slidingly receiving the lift band. The lift band is coupled to the bottom end of the shade fabric, such that bottom end of the shade fabric moves up and down as the roller tube is rotated in respective directions, so as to raise and lower the shade fabric.

### CROSS REFERENCE TO RELATED APPLICATIONS

This application claims priority from commonly-assigned U.S. Provisional Patent Application No. 61/180,538, filed May 22, 2009, and U.S. Provisional Patent Application No. 61/240,064, filed Sep. 4, 2009, both entitled ROMAN SHADE SYSTEM, the entire disclosures of which is hereby incorporated by reference.

### BACKGROUND OF THE INVENTION

1. Field of the Invention

The present invention relates to window treatments, and more particularly, to a roman shade system.

2. Description of the Related Art

Typical window treatments, such as, for example, roller shades, draperies, roman shades, and venetian blinds, are mounted in front of windows to prevent sunlight from entering a space and to provide privacy. FIG. 1 is a front perspective view and FIG. 2 is a rear perspective view of a prior art roman shade system 10 in a fully-closed position. FIG. 3 is a front perspective view of the prior art roman shade system 10 in a partially-open position. The roman shade system 10 includes a “hobbled” shade fabric 12 that is adapted to fold into a plurality of horizontal pleats 14 as the roman shade system 10 is opened (as shown in FIG. 3). The pleats 14 are formed by rigid battens 16 (or dowels), which are sewn into the shade fabric 12 and extend horizontally across the width of the shade fabric. The roman shade system 10 comprises two ribbons 20 that extend along the length a rear surface 18 of the shade fabric 12 and are attached to the rear surface of the shade fabric at the battens 16. Accordingly, the shade fabric 12 hangs with a plurality of folds 22 when the roman shade system 10 is fully closed as shown in FIGS. 1 and 2.

Three cords 24 are attached to a lowest one of the battens 16A and extend from the lowest batten 16A to a roller tube 26. The two cords 24 are slidingly received through a plurality of eyelets 28 (which are attached to the battens 16) and are windingly received around the roller tube 26, for example, in spools 30 on the roller tube. Rather than including cords 24, some prior art roman shade systems have included ribbons having widths of ¼ inch or less. As the roller tube 26 is rotated such that the cords 24 wrap around the roller tube, the lowest batten 16A is pulled in an upward direction along with the shade fabric 12 of a lowest fold 22A. When the lowest batten 16A contacts the next highest batten 16, both battens then move together in the upward direction. In this way, the shade fabric 12 of the roman shade system 10 is raised and lowered. Often, the roller tube 26 may be controlled by a motor (not shown), which may be located within the roller tube.

If the movement of the shade fabric 12 or any of the battens 16 is hindered while the shade fabric is being lowered, then one or more of the cords 24 may become slack and may then become tangled when the shade fabric 12 is once again raised. Thus, the roman shade system 10 may need to be serviced before the system is once again operational. Accordingly, there is a need for an improved roman shade system in which tangling of the cords 24 is avoided.

### SUMMARY OF THE INVENTION

According to the embodiments of the present invention, a shade system for opening and closing a shade fabric (such as a roman shade fabric) comprises at least one wide flexible lift band (i.e., a flexible material) that is less susceptible to tangling than the prior art cords. The shade fabric has a top end and a bottom end and is adapted to move between a fully-open position and a fully-closed position. The flexible material has a first end connected to a rotatably-mounted roller tube that is mounted adjacent the top end of the shade fabric, such that the flexible material is windingly received around the roller tube. The shade system further comprises a plurality of coupling structures for holding the flexible material adjacent to a rear surface of the shade fabric. Each of the coupling structures is attached to the rear surface of the shade fabric at attachment points that are spaced apart by an offset distance, such that the coupling structures and the shade fabric form openings for receiving the flexible material. The flexible material is slidingly received through the openings formed by the coupling structures and the shade fabric. The second end of the flexible material is coupled to the shade fabric adjacent the bottom end of the shade fabric, such that the bottom end of the shade fabric is adapted to move in an upward direction and in a downward direction as the roller tube is rotated in respective first and second directions, so as to respectively raise and lower the shade fabric. The shade fabric may comprises a roman shade fabric adapted to form a plurality of horizontal pleats as the shade fabric moves towards the fully-open position.

According to one embodiment of the present invention, the flexible material may have a width that is slightly less than the offset distance and may be positioned between the attachment points at which the coupling structures are connected to the rear surface of the shade fabric. According to another embodiment of the present invention, the shade system may include at least two parallel lift bands, which are windingly received about the roller tube and each have a width greater than or equal to approximately six inches. The lift bands may each comprise a flexible mesh material. According to another embodiment of the present invention, the shade system may comprise at least two sections of flexible material, where a total width of the sections of flexible material is approximately 37.5% or greater of a width of the shade fabric. According to yet another embodiment of the present invention, each of the sections of flexible material may have a width greater than or equal to approximately three inches to avoid tangling.

In addition, a flexible material attachment mechanism for attaching a flexible material (i.e., a lift band) to a shade fabric of a shade system is also described herein. The flexible material attachment mechanism comprises an outer enclosure, an elongated ratchet bard, and a locking structure. The outer enclosure has an elongated, cylindrical cavity and an elongated opening allowing for receipt of the flexible material into the cavity. The elongated ratchet bar is received within the cavity of the outer enclosure, such that the flexible material may be positioned between the ratchet bar and the outer enclosure. The locking structure is adapted to be coupled to both the ratchet bar and the outer enclosure to fix the ratchet bar in position with respect to the outer enclosure. When the locking structure is not coupled to both the ratchet bar and the outer enclosure, the ratchet bar is adapted to be rotated to adjust the amount of the first lift band that is received within the cavity. When the locking structure is coupled to both the ratchet bar and the outer enclosure, the ratchet bar and the first lift band are fixed in position with respect to the outer enclosure.

According to another aspect of the present invention, a shade system for covering an opening comprises a shade fabric for covering the opening, a rotatably-mounted roller tube mounted adjacent a top end of the shade fabric, a support member located between the roller tube and the opening, and a flexible member windingly received around the roller tube for raising and lowering the shade fabric. The shade fabric is adapted to move between a fully-open position and a fully-closed position, and the top end of the shade fabric is fixedly attached to the support member. The flexible member has a first end connected to the roller tube and a second end, which is opposite the first end and is connected to the shade fabric adjacent a bottom end of the shade fabric. The flexible member is draped across an edge of the support member and extends from the bottom end of the shade fabric to the roller tube adjacent to a rear surface of the shade fabric. The second end of the flexible member is adapted to move in an upward direction and in a downward direction as the roller tube is rotated in respective first and second directions, so as to respectively raise and lower the shade fabric. The flexible member may comprise a flexible sheet received around the roller tube.

Other features and advantages of the present invention will become apparent from the following description of the invention that refers to the accompanying drawings.

### BRIEF DESCRIPTION OF THE DRAWINGS

The invention will now be described in greater detail in the following detailed description with reference to the drawings in which:

FIG. 1 is a front perspective view of a prior art roman shade system in a fully-closed position;

FIG. 2 is a rear perspective view of the prior art roman shade system of FIG. 1 in the fully-closed position;

FIG. 3 is a front perspective view of the prior art roman shade system of FIG. 1 in a partially-open position;

FIG. 4 is a front perspective view of a flat roman shade system according to a first embodiment of the present invention;

FIG. 5 is a rear perspective view of the roman shade system of FIG. 4;

FIG. 6 is a front perspective view of the roman shade system of FIG. 4 in a partially-open position;

FIG. 7 is a rear view of the roman shade system of FIG. 4;

FIG. 8 is a left side view of the roman shade system of FIG. 4;

FIG. 9 is a rear perspective view of a roman shade system having alternate coupling structures according to a second embodiment of the present invention;

FIG. 10 is a rear perspective view of a roman shade system having coupling structures comprising pieces of shade fabric material according to a third embodiment of the present invention;

FIG. 11 is a front perspective view of a knife-fold roman shade system according to a fourth embodiment of the present invention;

FIG. 12 is a rear perspective view of the roman shade system of FIG. 11;

FIG. 13 is a rear view of the roman shade system of FIG. 11;

FIG. 14 is a left side view of the roman shade system of FIG. 11;

FIG. 15 is a top cross-sectional view of the roman shade system of FIG. 11;

FIG. 16 is a top cross-sectional view of a roman shade system according to an alternate embodiment of the present invention;

FIG. 17 is a front perspective view of a hobbled roman shade system according to a fifth embodiment of the present invention;

FIG. 18 is a rear perspective view of the roman shade system of FIG. 17;

FIG. 19 is a rear view of the roman shade system of FIG. 17;

FIG. 20 is a left side view of the roman shade system of FIG. 17;

FIG. 21 is a rear perspective view of a roman shade system according to a sixth embodiment of the present invention;

FIG. 22 is a top cross-sectional view of the roman shade system of FIG. 21;

FIG. 23 is a top cross-sectional view of a roman shade system according to an alternate embodiment of the present invention;

FIG. 24 is a rear perspective view of a roman shade system according to a seventh embodiment of the present invention;

FIG. 25 is a rear perspective view of a roman shade system according to an eighth embodiment of the present invention;

FIG. 26 is an enlarged perspective view of a portion of the roman shade system of FIG. 25 showing end caps in greater detail;

FIG. 27 is an exploded perspective view of a portion of the roman shade system of FIG. 25 showing how a band clamp is attached to a section of flexible material and a lower external batten;

FIG. 28 is an enlarged perspective view of the band clamp of FIG. 27;

FIG. 29 is a rear perspective view of a roman shade system having lift band attachment mechanisms according to a ninth embodiment of the present invention;

FIG. 30 is a left side view of the roman shade system of FIG. 29;

FIG. 31 is an enlarged bottom perspective view of one of the lift band attachment mechanisms of the roman shade system of FIG. 29;

FIG. 32 is a partially-exploded bottom perspective view of the lift band attachment mechanism of FIG. 31;

FIG. 33 is a partially-exploded top view of the lift band attachment mechanism of FIG. 31;

FIG. 34 is an enlarged right side cross-sectional view of the lift band attachment mechanism of FIG. 31;

FIG. 35 is a rear perspective view of a roman shade system having a front control assembly according to a tenth embodiment of the present invention;

FIG. 36 is a rear perspective view of the roman shade system of FIG. 35;

FIG. 37 is a left side view of the roman shade system of FIG. 35;

FIG. 38 is an enlarged rear perspective view of the roman shade system of FIG. 35; and

FIG. 39 is a rear perspective view of a roman shade system having a front control assembly according to an eleventh embodiment of the present invention.

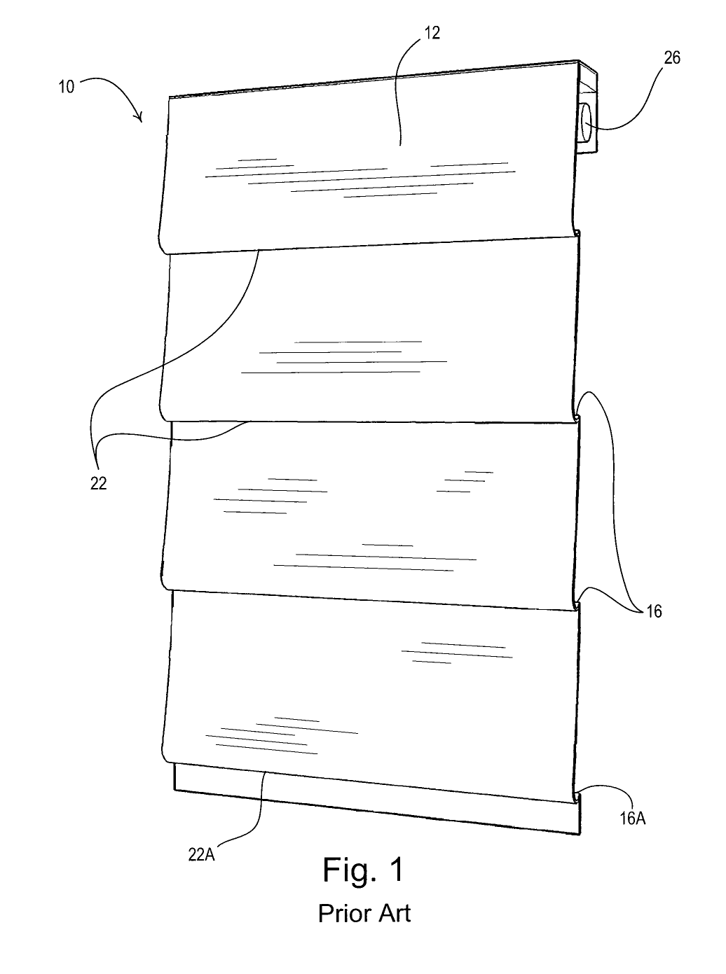

### DETAILED DESCRIPTION OF THE INVENTION

The foregoing summary, as well as the following detailed description of the embodiments of the present invention, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

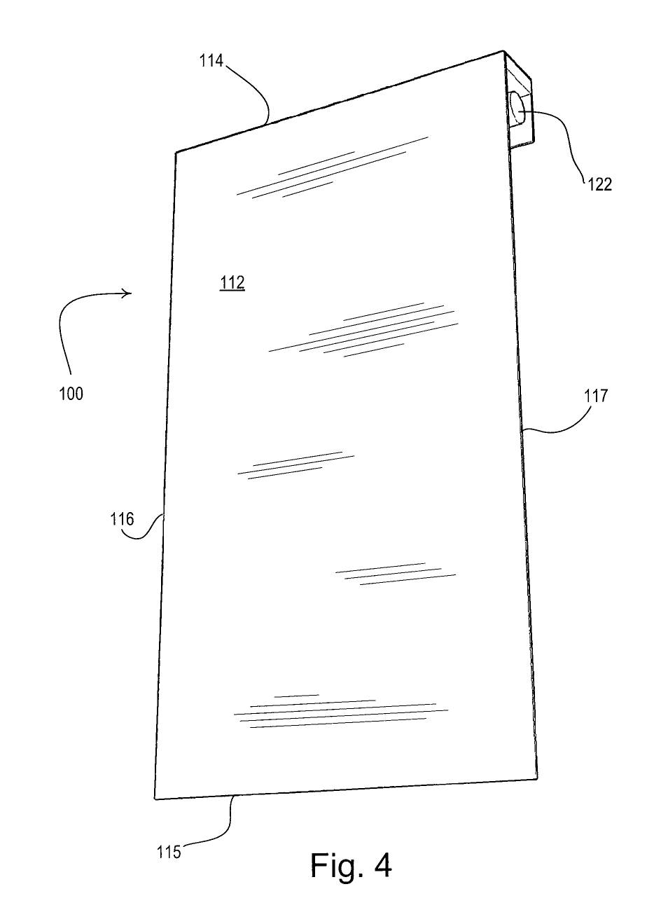

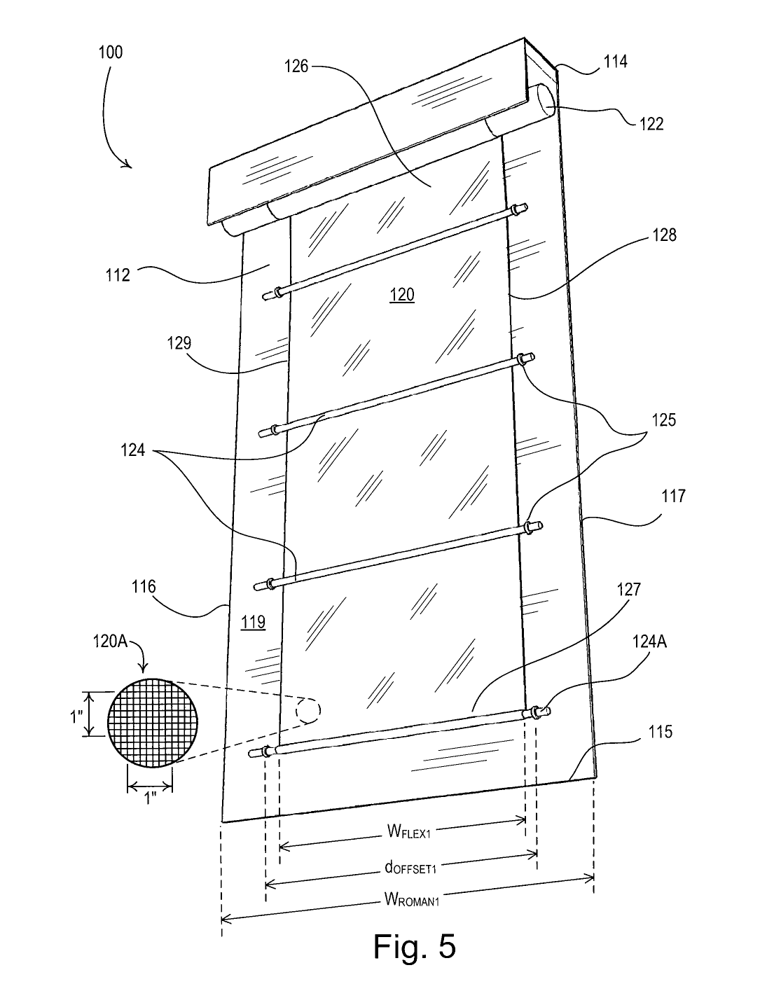

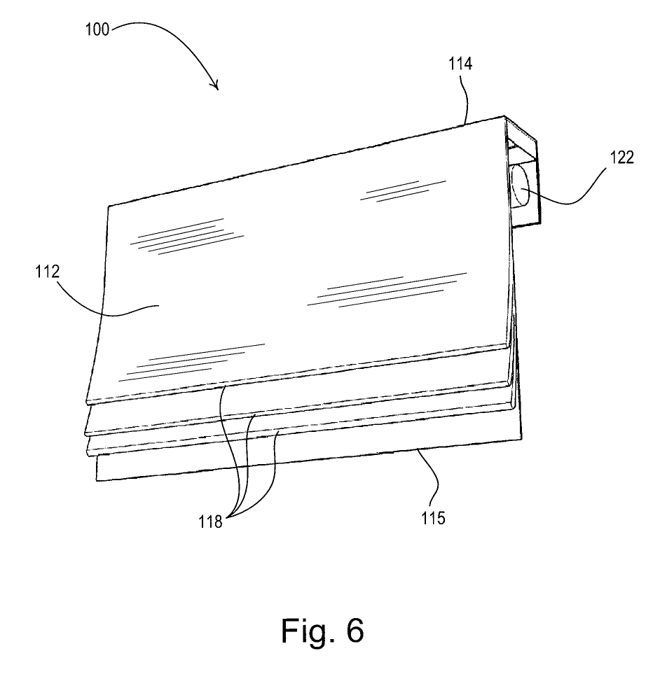

FIG. 4 is a front perspective view and FIG. 5 is a rear perspective view of a roman shade system 100 according to a first embodiment of the present invention. The roman shade system 100 of the first embodiment has a flat roman shade fabric 112, which extends from a top end 114 to a bottom end 115 for covering an opening, such as a window. The roman shade fabric 112 is characterized by a width W_{ROMAN1} between two opposing side edges 116, 117 of the shade fabric. The roman shade system 100 is operable to raise and lower the bottom end 115 of the roman shade fabric 112 between a fully-closed position (in which the shade fabric 112 is fully covering the window as shown in FIG. 4) and a fully-open position (in which the entire length of the window or at least a portion of the window is not covered by the shade fabric 112 as shown in FIG. 6). The roman shade fabric 112 is folded into a plurality of horizontal pleats 118 as the roman shade system is opened as shown in FIG. 6. The fully-open position of the roman shade system 100 is determined by the amount of shade fabric 112 that must be bunched up near the top end 114 when the roman shade system is open.

As shown in FIG. 5, the roman shade system 100 of the first embodiment of the present invention comprises a wide lift band 120 (e.g., comprising a wide flexible material or sheet) that allows for movement of the bottom end 115 of the shade fabric 112 in upward and downward directions. For example, the flexible material of the lift band 120 may be similar to a shade fabric of a roller shade system, which is well known to one of ordinary skill in the art. The lift band 120 is windingly received around a rotatably-mounted roller tube 122 to allow for movement of the shade fabric 112. The roller tube 122 is mounted adjacent to the top end 114 of the shade fabric 112, e.g., to a wall above the window, a ceiling above the window, or walls on each side of the window. Examples of roller tubes and shade fabrics for roller shade systems are described in greater detail in U.S. Pat. No. 6,497,267, issued Dec. 24, 2002, entitled MOTORIZED WINDOW SHADE WITH ULTRAQUIET MOTOR DRIVE AND ESD PROTECTION, the entire disclosure of which is hereby incorporated by reference.

If the roman shade fabric 112 is a sheer fabric, the lift band 120 may be made from a translucent material to allow some sunlight to shine through the roman shade fabric and the flexible material. The flexible material of the lift band 120 may also comprise a mesh material 120A (as shown in FIG. 5), e.g., manufactured by Phifer Incorporated. For example, the mesh material 120A may be made from fiberglass strands, which have diameters of approximately 0.005 inches and are coated with polyvinyl chloride (PVC). The mesh size of the mesh material 120A may be, for example, 8×8 (i.e., there are eight vertical strands and eight horizontal strands in one square inch of the mesh material). Alternatively, the mesh material 120A could comprise a leno weave of polyester strands (e.g., each having a diameter of approximately 0.003 inches). The warp yarns (i.e., vertical strands) of the leno weave may each comprise two polyester strands twisted together, while the fill yarns (i.e., horizontal strands) may each comprise a single polyester strand. The mesh size of the leno weave may be, for example, 9×18 (i.e., there are nine warp yarns and eighteen fill yarns in one square inch of the leno weave).

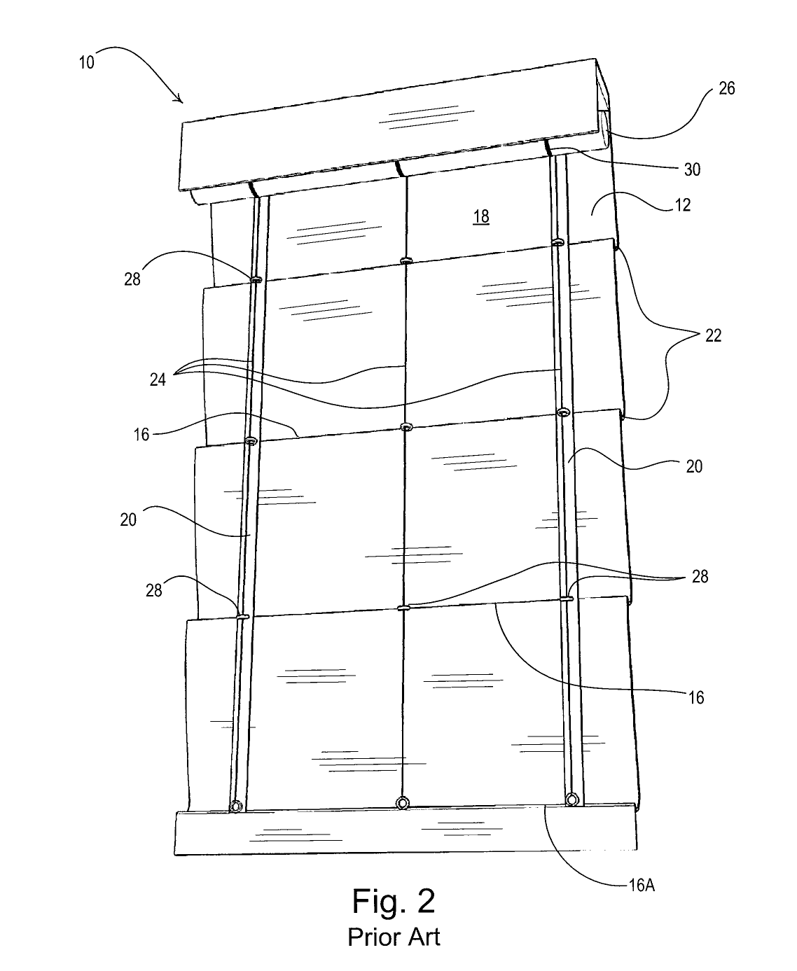

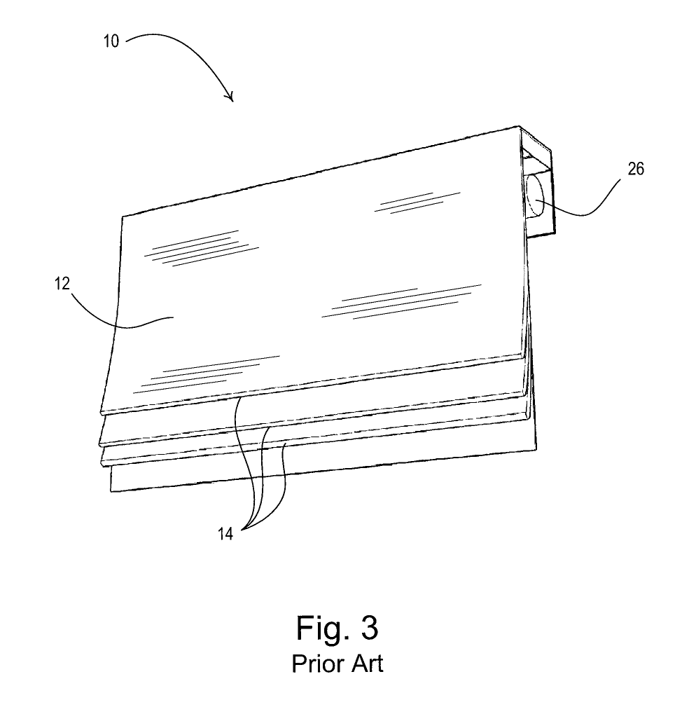

The lift band 120 has a first top end 126, a second bottom end 127 opposite the first end, and has two opposing side edges 128, 129. The first end 126 of the lift band 120 is connected to the roller tube 122, and the second end 127 is coupled to the roman shade fabric 112 adjacent the bottom end 115 of the roman shade fabric. The flexible material 120 is windingly received around the roller tube 122, such that the second end of the flexible material and thus the bottom end 115 of the shade fabric 112 are adapted to move in the upward direction and in the downward direction as the roller tube 122 is rotated in respective first and second directions, so as to respectively raise and lower the roman shade fabric. The lift band 120 is able to wrap around the roller tube 122 without requiring a spool (e.g., the spool 30 of the prior art roman shade system 10 shown in FIG. 2).

The roman shade system 100 comprises a plurality of coupling structures for holding the lift band 120 adjacent to a rear surface 119 of the shade fabric 112. Specifically, the roman shade system 100 comprises a plurality of elongated rigid members, such as external battens 124, and two vertical columns of eyelets 125 that are attached to the rear surface 119 of the shade fabric 112. The external battens 124 extend horizontally through one of the eyelets 125 in each of the columns, such that the eyelets operate as attachment points for coupling the battens to the rear surface 119 of the shade fabric 112. The two columns of eyelets 125 (i.e., the attachment points of the battens 124) are located adjacent to the side edges 116, 117 of the shade fabric 112 and are horizontally spaced apart from each other by an offset distance d_{OFFSET1}. Accordingly, each of the battens 124 extends for the length of the offset distance d_{OFFSET1} between the two eyelets 125 through which the batten extends. Typically, there is a distance of approximately 1 to 2 inches between each of the eyelets 125 and the adjacent side of the roman shade fabric 112, e.g., as defined by the Window Covering Manufacturers Association (WCMA). Thus, the offset distance d_{OFFSET1} may be approximately 16 inches when the shade fabric 112 has a width W_{ROMAN1} of approximately 18 to 20 inches.

The lift band 120 may be fixedly attached to a lowest one of the battens 124A, which is located adjacent to the bottom end 115 of the shade fabric 112, e.g., as close as approximately one inch from the bottom end of the shade fabric. The lift band 120 extends from the lowest batten 124A to the roller tube 122, and is slidingly received through openings formed by the external battens 124, the eyelets 125 (through which the respective batten is received), and the adjacent shade fabric 112. Thus, the lift band 120 is positioned between two columns of the eyelets 125 and is adapted to move through the openings of the coupling structures as the roller tube 122 is rotated. When the roller tube 122 is rotated such that the lift band 120 wraps around the roller tube, the lowest batten 124A is pulled in the upward direction. The lowest batten 124A will then contact the next adjacent batten 124 (and so on) as the roman shade system 100 is opened thus forming the pleats 118 in the shade fabric 112.

The roman shade system 100 may also comprise a motor drive system (not shown) to allow for control of the rotation of the roller tube 122 by a user of the roman shade system. An example of a motor drive system for controlling the rotation of a roller tube is described in greater detail in U.S. Pat. No. 6,983,783, issued Jan. 10, 2006, entitled MOTORIZED SHADE CONTROL SYSTEM, the entire disclosure of which is hereby incorporated by reference. Alternatively, the roman shade system 100 could comprise a manual drive system. An example of a manual drive system for controlling the rotation of a roller tube is described in greater detail in U.S. patent application Ser. No. 11/985,418, filed Nov. 15, 2007, entitled ROLLER SHADE CLUTCH ASSEMBLY, the entire disclosure of which is hereby incorporated by reference.

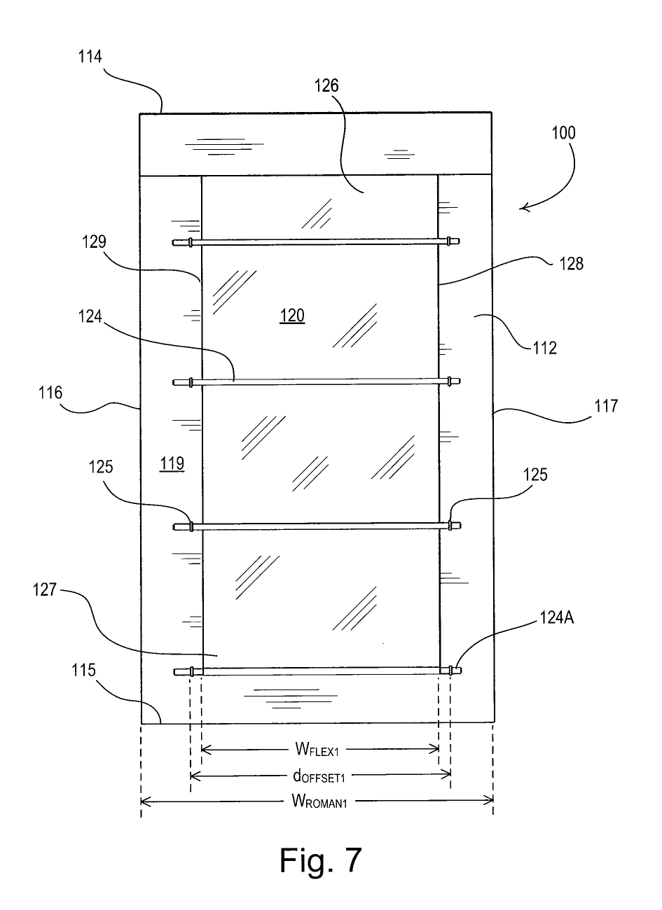

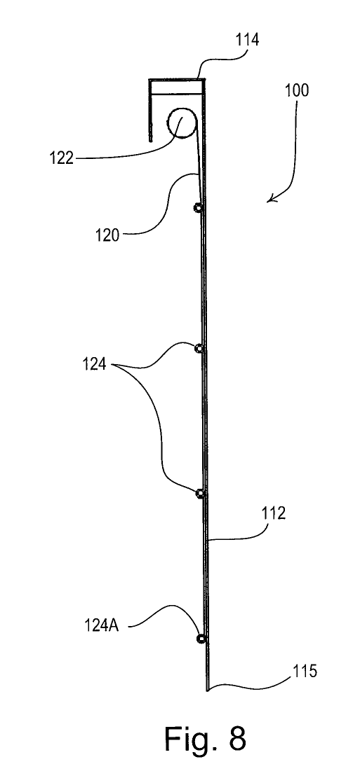

FIG. 7 is a rear view and FIG. 8 is a left side view of the roman shade system 100 according to the first embodiment of the present invention. The lift band 120 is characterized by a width W_{FLEX1} as shown in FIGS. 5 and 7 (i.e., between the side edges 128, 129). The width W_{FLEX1} of the lift band 120 is slightly smaller than the distances between the eyelets 125 of one of the battens 124 (i.e., the offset distance d_{OFFSET1}). For example, there should be a clearance of approximately one inch between the eyelets 125 and the side edges 128, 129 of the lift band 120. Therefore, if the shade fabric 112 has a width W_{ROMAN1} of approximately 18 to 20 inches, the eyelet offset distance d_{OFFSET1} may be approximately 16 inches and thus the lift band 120 may have a width W_{FLEX1} of approximately 14 inches. In other words, the width W_{FLEX1} of the lift band 120 is at least approximately 70% of the width W_{ROMAN1} of the shade fabric 112 and may be as small as 50% of the width W_{ROMAN1} of the shade fabric according to the first embodiment of the present invention.

Therefore, since the roman shade system 100 of the first embodiment of the present invention does not include the cords 24 of the prior art roman shade system 10, tangling of the cords is avoided. In addition, the lift band 120 of the first embodiment wraps around the roller tube 122 in a more orderly fashion than the cords 24 of the prior art roman shade system 10.

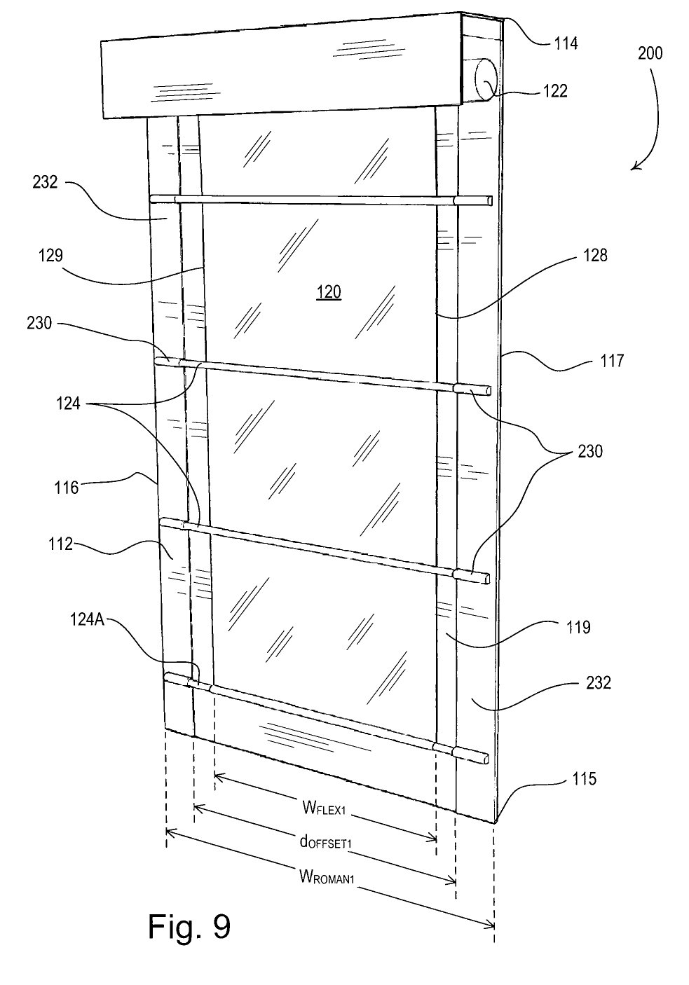

FIG. 9 is a rear perspective view of a roman shade system 200 in the fully-closed position according to a second embodiment of the present invention. The roman shade system 200 of the second embodiment has different coupling structures for holding the lift band 120 adjacent the rear surface 119 of the shade fabric 112 than the roman shade system 100 of the first embodiment. Rather than including the eyelets 125 for supporting the external battens 124, the roman shade system 200 comprises a plurality of cylindrical pockets 230. The shade fabric 112 of the roman shade system 100 is folded over to create hems 232 at the side edges 116, 117 of the shade fabric. The pockets 230 are constructed from, for example, the material of the hems 232 of the shade fabric 112 along the side edges 116, 117 of the shade fabric, i.e., the pockets are sewn (or otherwise suitably affixed) to the rear surface 119 of the shade fabric. The pockets 230 have open ends for receiving and holding the ends of the external battens 124. The lift band 120 is positioned between the two columns of pockets 230 (i.e., between the hems 232) and is slidingly received between the external battens 124 and the shade fabric 112.

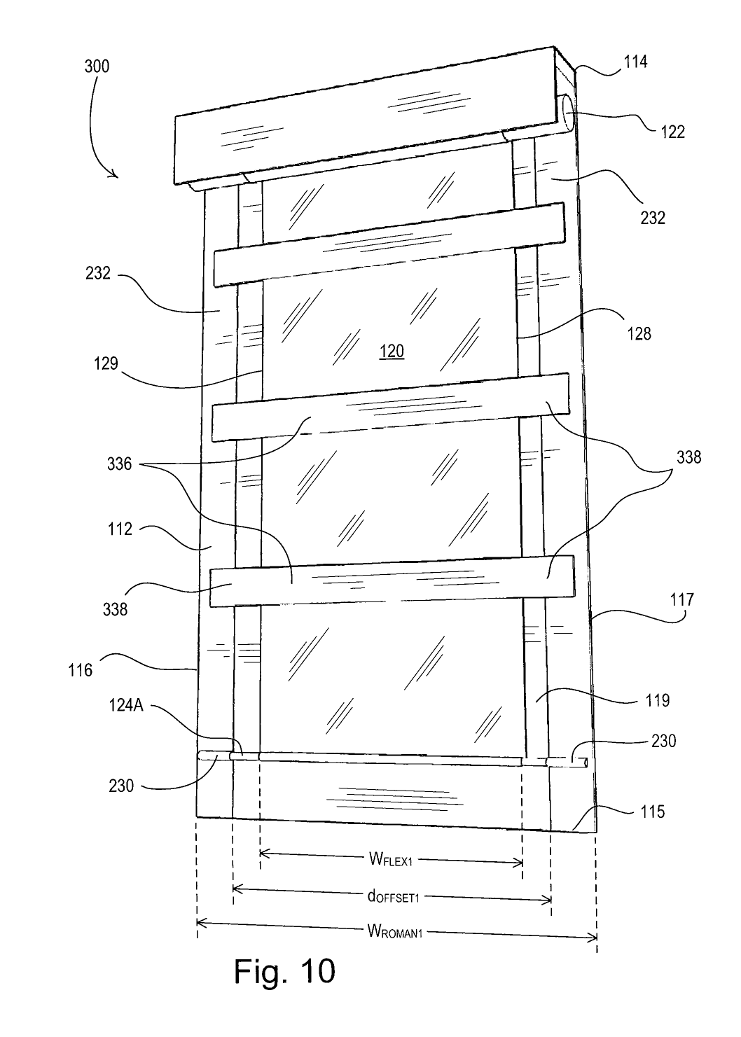

FIG. 10 is a rear perspective view of a roman shade system 300 in the fully-closed position according to a third embodiment of the present invention. Rather than including the external battens 124 and the eyelets 125 of the first embodiment, the roman shade system 300 according to the third embodiment comprises a plurality of elongated pieces of shade fabric material 336, which operate as the coupling structures for holding the lift band 120 adjacent the rear surface 119 of the shade fabric 112. The elongated pieces of shade fabric material 336 are sewn to the rear surface 119 of the shade fabric 112 at attachments points 338, which are located adjacent to the side edges 116, 117 of the shade fabric 112. The elongated pieces of shade fabric material 336 extend horizontally between the attachment points 338 for the length of the offset distance d_{OFFSET1}, i.e., in approximately the same position as the external battens 124 of the first embodiment as shown in FIG. 5. The lift band 120 is attached to the lowest batten 124A and is slidingly received between the elongated pieces of shade fabric material 340 and the shade fabric 112. Alternatively, the lift band 120 could be attached directly to the shade fabric adjacent to the bottom end 115 of the shade fabric 112.

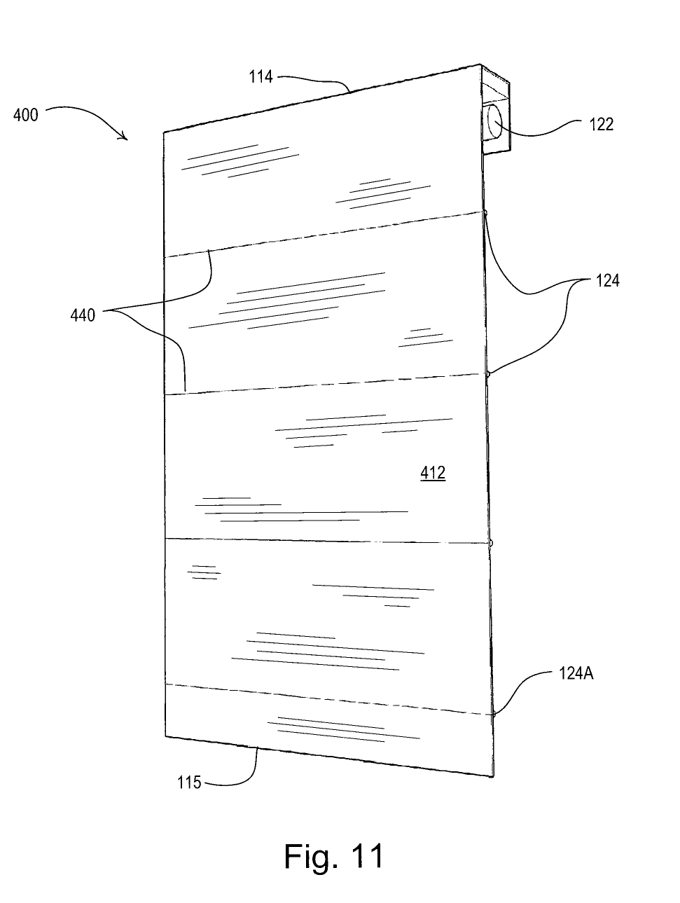

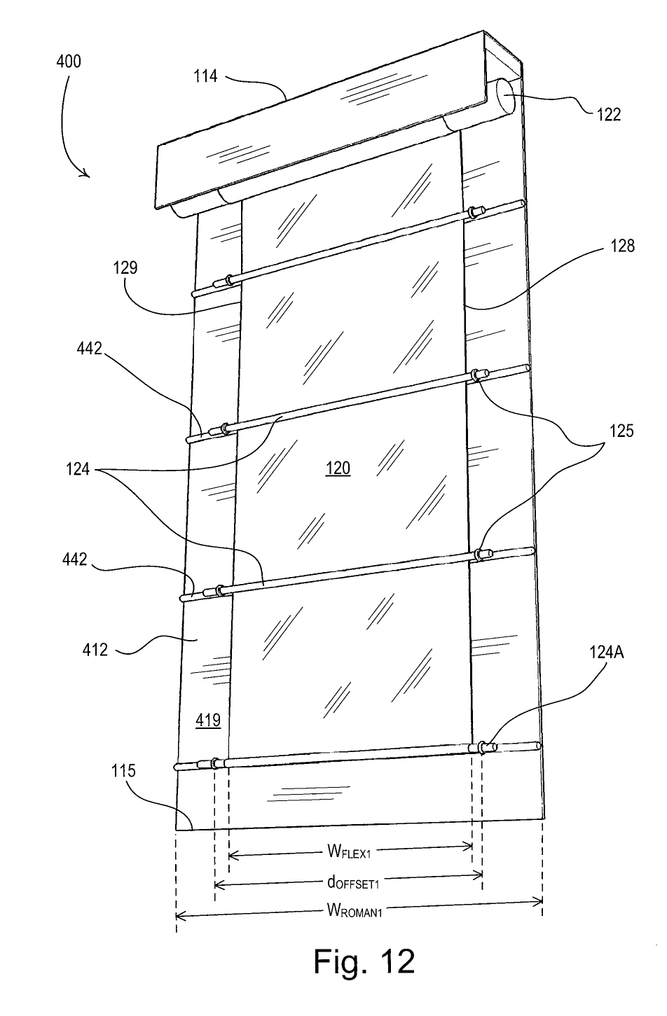

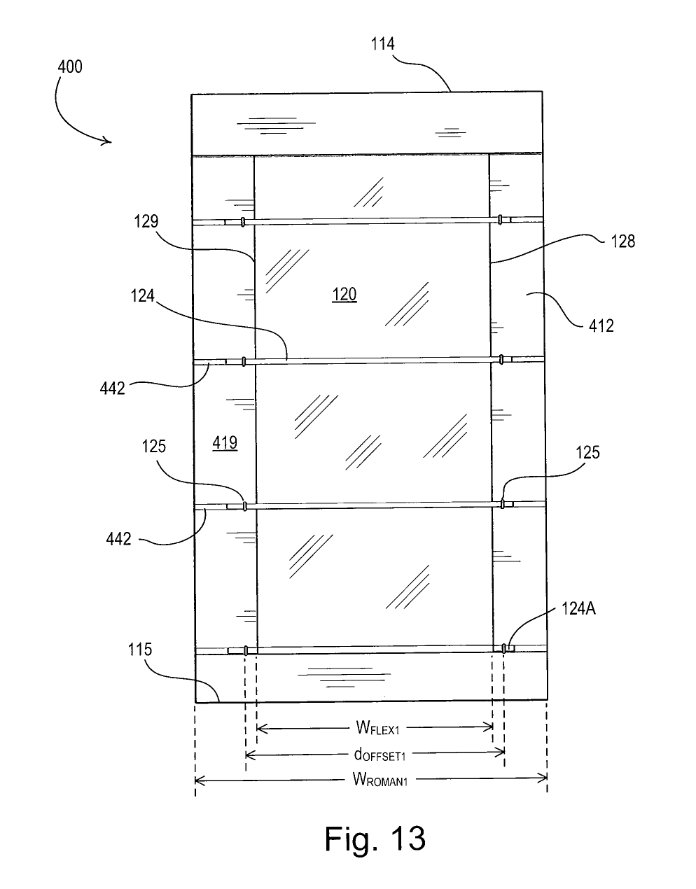

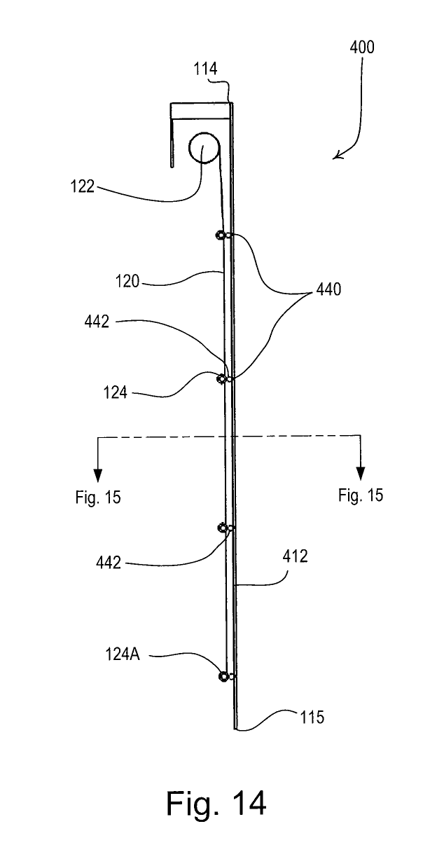

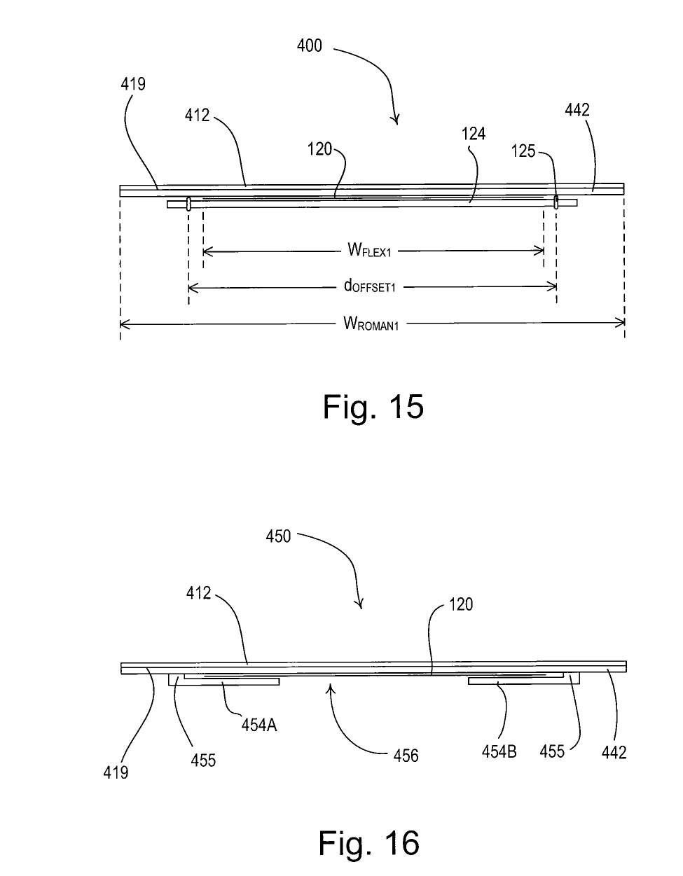

FIG. 11 is a front perspective view and FIG. 12 is a rear perspective view of a roman shade system 400 according to a fourth embodiment of the present invention. The roman shade system 400 of the fourth embodiment has a “knife-fold” roman shade fabric 412, which comprises a plurality of thin, horizontal folds 440 when the roman shade system is closed. FIG. 13 is a rear view and FIG. 14 is a left side view of the roman shade system 400 according to the fourth embodiment of the present invention. FIG. 15 is a top cross-sectional view of the roman shade system 400 taken through the line shown in FIG. 14. The folds 440 are formed by rigid fold-forming battens 442, which extend horizontally across a rear surface 419 of the shade fabric 412. A portion of the shade fabric 412 loops through each of the fold-forming battens 442 and pinches the shade fabric to form the respective fold 440. The eyelets 125 are attached to the fold-forming battens 442 and the external battens 124 extend through the eyelets, such that each of the external battens is adjacent and parallel to one of the fold-forming battens. The lift band 120 is attached to the lowest batten 124A and is slidingly received between the external battens 124 and the corresponding fold-forming battens 442. The lowest batten 124A may be located, for example, approximately 4 to 8 inches from the bottom end 115 of the shade fabric 112. An example of a fold-forming batten is described in greater detail in U.S. Pat. No. 6,257,300, Jul. 10, 2007, entitled ROMAN SHADE FOLD FORMING BATTEN, the entire disclosure of which is hereby incorporated by reference.

Alternatively, the coupling structures may not fully encircle the lift band 120, but may only partially surround the lift band by an amount enough to ensure that the lift band is maintained adjacent the rear surface 419 of the shade fabric 410. FIG. 16 is a top cross-sectional view of a roman shade system 450 according to an alternate embodiment. Each of the coupling structures of the roman shade system 450 of FIG. 16 comprises a pair of rigid fingers 454 that are connected to each of the fold-forming battens 442 via respective attachment members 455. The rigid fingers 454 extend towards each other, such that each pair of rigid fingers forms an opening for receiving the lift band 120. Accordingly, each pair of rigid fingers 454 operates to partially surround the lift band 120 and maintain the lift band adjacent the rear surface 419 of the shade fabric 410. A gap 456 is formed between the rigid fingers 454 and allows the lift band 120 to be slightly folded, such that the lift band may be removed from the rigid fingers and no longer held adjacent the rear surface 119 of the shade fabric 112.

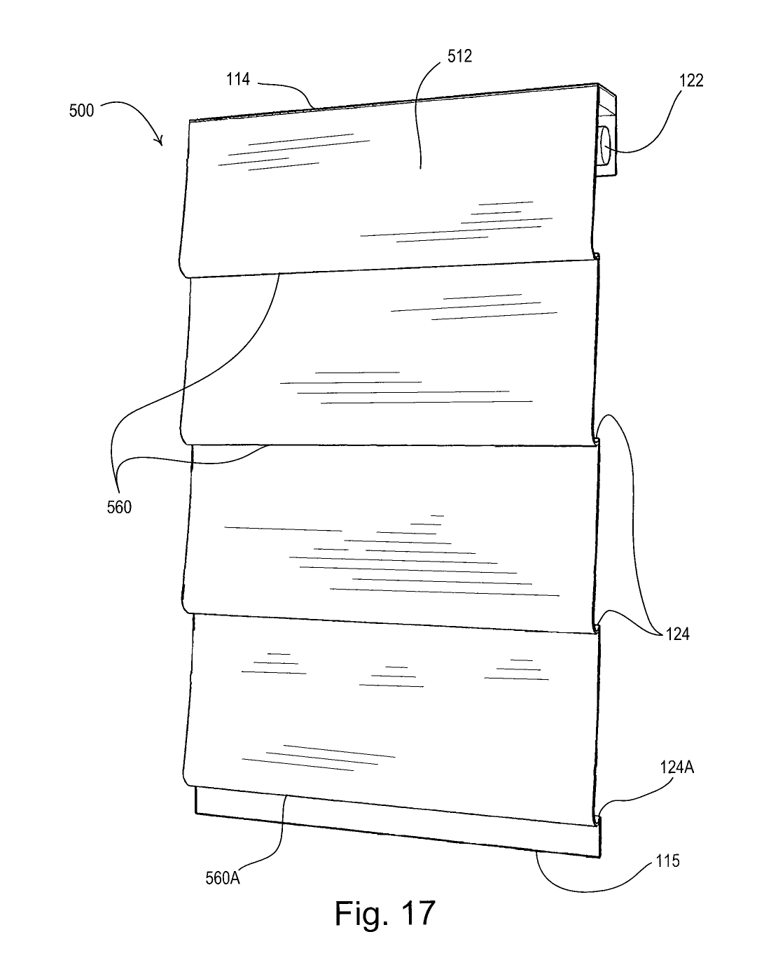

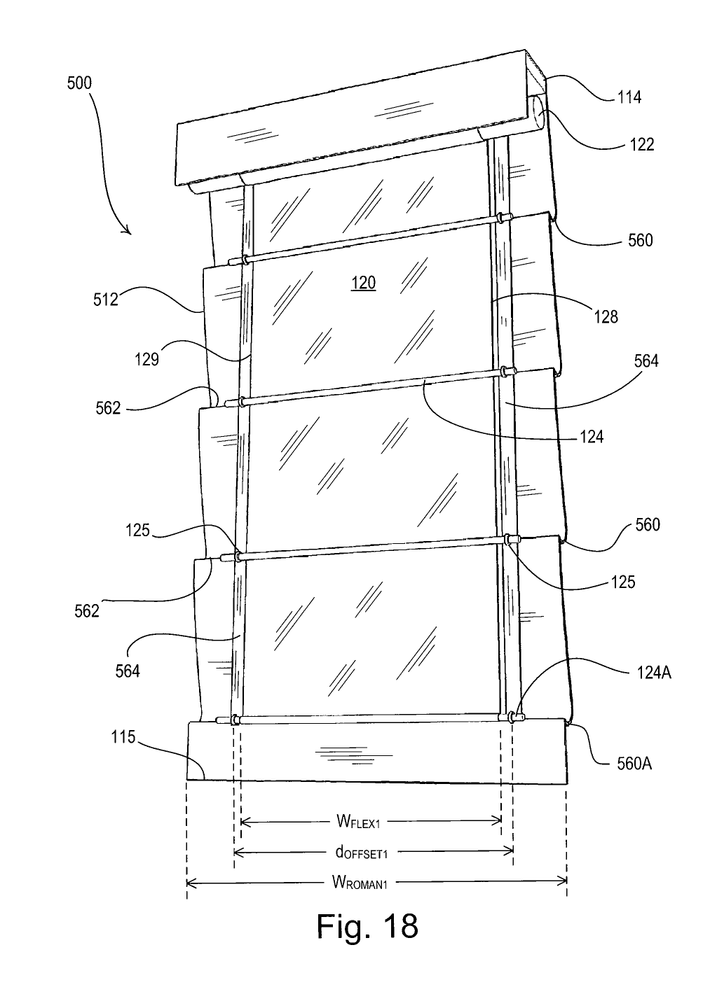

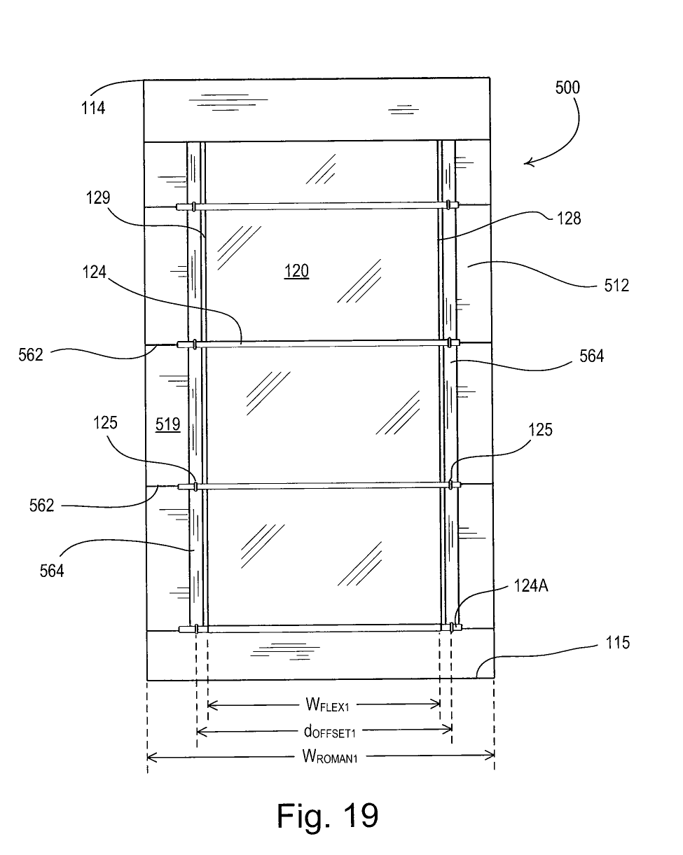

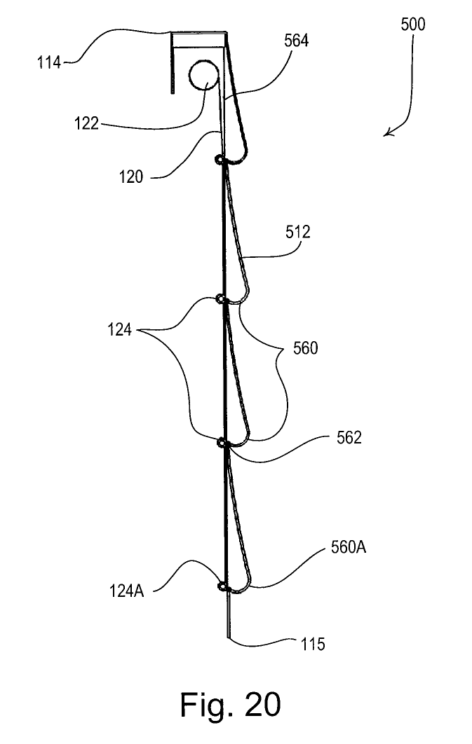

FIG. 17 is a front perspective view and FIG. 18 is a rear perspective view of a roman shade system 500 according to a fifth embodiment of the present invention. The roman shade system 500 of the fifth embodiment has a hobbled roman shade fabric 512, which hangs in a plurality of horizontal folds 560. FIG. 19 is a rear view and FIG. 20 is a left side view of the roman shade system 500 according to the fifth embodiment of the present invention. The roman shade system 500 comprises a plurality of internal battens 562, which are sewn into the shade fabric 512 and extend horizontally across the width of the roman shade fabric. The two columns of eyelets 125 are attached to the internal battens 562. The external battens 124 are received through one of the eyelets 125 in each of the columns and extend along a rear surface 519 of the shade fabric 512, such that each of the external battens is adjacent and parallel to one of the internal battens 562. The lift band 120 is thus slidingly received between the external battens 124 and adjacent internal batten 562 sewn in the shade fabric 512. As the roller tube 122 is rotated such that the lift band 120 wraps around the roller tube, the lowest batten 124A is pulled in an upward direction along with the shade fabric 512 of a lowest fold 560A.

The roman shade system 500 further comprises two ribbons 564, which extend from the lowest batten 124A to the top end 114 of the roman shade fabric 512. The two ribbons 564 are attached to each of the internal battens 562 and the lift band 120 is positioned between the two ribbons. The length of each ribbon 564 between two adjacent internal battens 562 is less than the length of the shade fabric 512 between the two adjacent internal battens, such that the shade fabric hangs with the folds 560 when the roman shade system 500 is open.

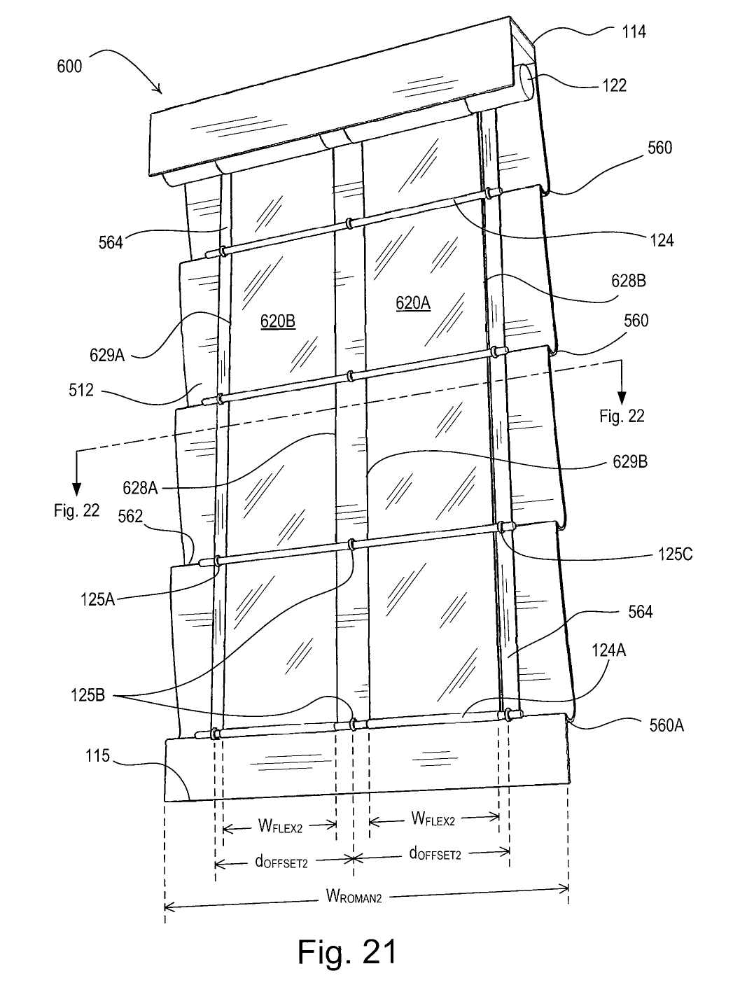

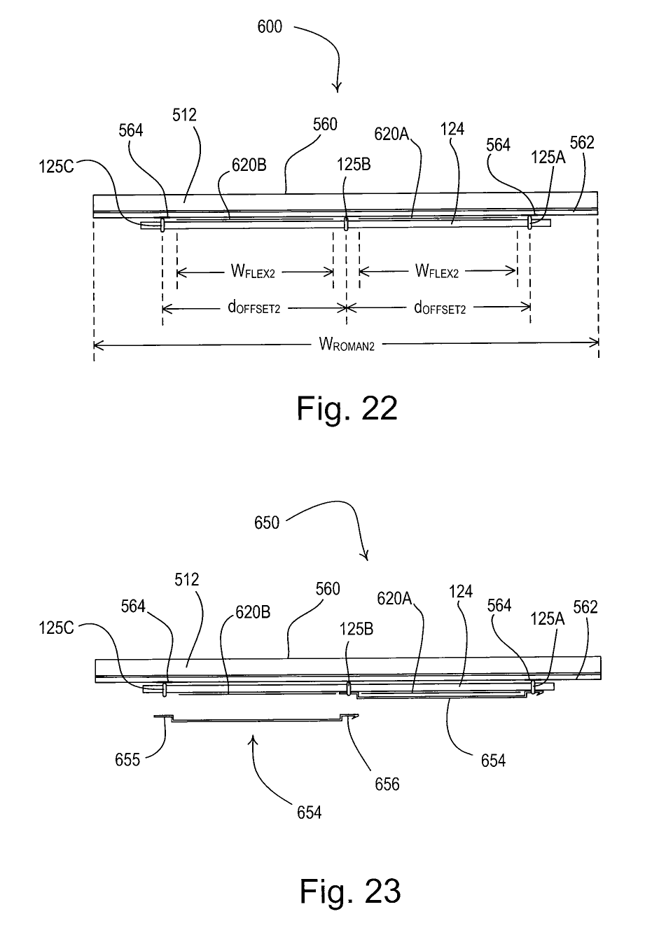

FIG. 21 is a rear perspective view of a roman shade system 600 according to a sixth embodiment of the present invention. FIG. 22 is a top cross-sectional view of the roman shade system 600 taken through the line shown in FIG. 21. The roman shade system 600 comprises three columns of eyelets 125A, 125B, 125C. The outermost columns of eyelets 125A, 125C are spaced apart from the innermost column of eyelets 125B by equal distances, i.e., offset distances d_{OFFSET2}. The column of eyelets 125B near the center of the shade fabric 512 provides additional support for the shade fabric, such that the roman shade system 600 of the sixth embodiment may include a wider shade fabric than the roman shade system 500 of the fifth embodiment (e.g., having a width W_{ROMAN2} greater than approximately 32 inches).

The roman shade system 600 comprises two lift bands 620A, 620B (i.e., two parallel sections of flexible material), which both wrap around the roller tube 122. The lift bands 620A, 620B each have respective opposing side edges 628A, 629A, 628B, 629B. Each lift band 620A, 620B has a width W_{FLEX2} (i.e., between the respective side edges 628A, 629A, 628B, 629B), such that the lift bands may be positioned between the outermost columns of eyelets 125A, 125C and the center column of eyelets 125B. As in the first embodiment, the width W_{FLEX2} of each of the lift bands 620A, 620B is slightly smaller than the distances between the adjacent eyelets (i.e., between the eyelets 125A and the eyelets 125B, and between the eyelets 125B and the eyelets 125C). Alternatively, additional columns of eyelets and thus additional lift bands could be provided to support even greater widths of shade fabric than may be supported by the roman shade system 600 as shown in FIG. 21.

FIG. 23 is a top cross-sectional view of a roman shade system 650 according to an alternate embodiment in which the lift bands 620A, 620B are positioned outside the external battens 124. The coupling structures of the roman shade system 650 of FIG. 23 comprise elongated band guides 654A, 654B, which provide detachable means of holding the lift bands 620A, 620B adjacent to the rear surface 519 of the shade fabric 512. The band guides 654A, 654B are positioned adjacent each of the external battens 124 and coupled to the eyelets 125A, 125B, 125C to hold the respective lift bands 620A, 620B adjacent to the rear surface 519 of the shade fabric 512. As shown in FIG. 23, the first band guide 654A is coupled to the first and second eyelets 125A, 125B to enclose the first lift band 620A, while the second band guide 654B is detached from the roman shade system 650. For example, the band guides 654 may be made from a fiberglass-reinforced material, such as, nylon, and may have a diameter of approximately 0.0625 inch.

Each band guide 654A, 654B comprises a flat attachment end 655 and an opposite barbed attachment end 656, and may be flexed (i.e., bent) slightly, such that flat and barbed attachment ends 655, 656 may be inserted inside the appropriate eyelets 125A, 125B, 125C (along with the respective external batten 124). The barbed attachment end 656 of each band guide 654A, 654B prevents backing out of the band guide. The flat attachment end 655 of each band guide 654A, 654B may be, for example, approximately two inches long to accommodate various spacings of the eyelets 125A, 125B, 125C (i.e., the offset distances d_{OFFSET2}) of different roman shade systems. Alternatively, the band guides 654A, 654B could comprise first ends that may be flexibly or pivotably attached to the external battens 124 and second, opposite ends that may be removeably attached (e.g., clipped or snapped) to the external battens. In addition, the band guides 654A, 654B could alternatively be positioned adjacent the internal battens 562, such that the lift bands are slidingly received between the band guides and the respective internal battens.

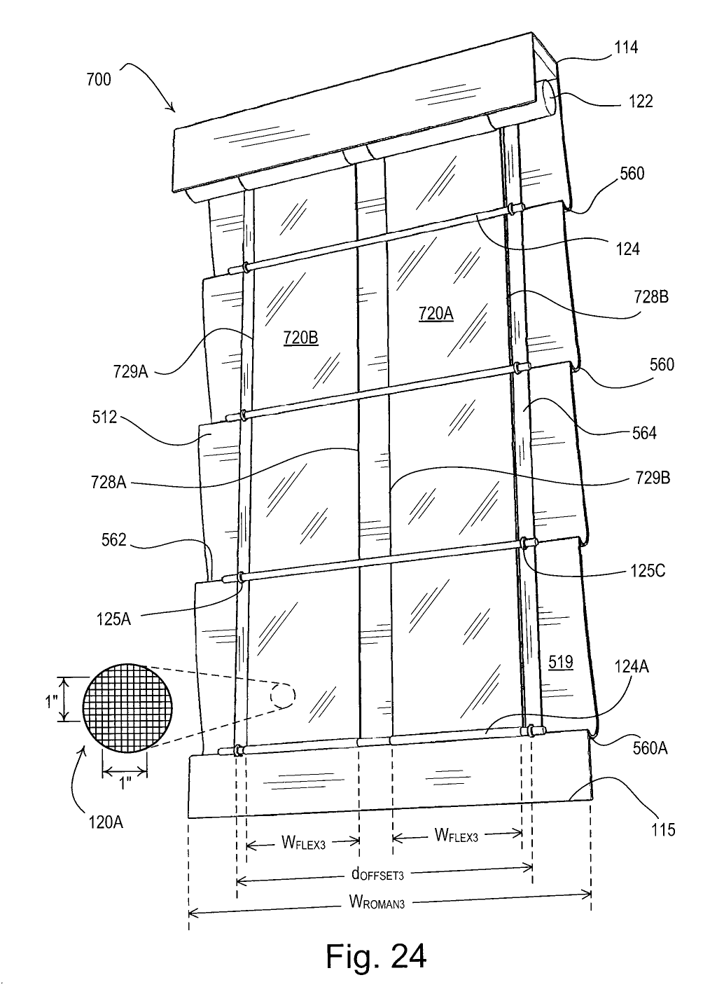

FIG. 24 is a rear perspective view of a roman shade system 700 according to a seventh embodiment of the present invention. The roman shade system 700 comprises two lift bands 720A, 720B, but does not include the center column of eyelets 125B (of the roman shade system 600 of the sixth embodiment). Therefore, the shade fabric 512 of the roman shade system 700 of the seventh embodiment has a width W_{ROMAN3} less than, for example, approximately 32 inches (i.e., as may be supported by only two columns of eyelets). The flexible material of the lift bands 720A, 720B may comprise, for example, the mesh material 120A (as shown in FIG. 5). Each lift band 720A, 720B has a width W_{FLEX3} (i.e., between respective side edges 728A, 729A, 728B, 729B). Preferably, lift bands 720A, 720B have minimum widths W_{FLEX3} of approximately 6 to 8 inches when the shade fabric 512 has a width W_{ROMAN3} of up to approximately 32 inches, such that the mesh material 120A is able to appropriately handle the load (i.e., weight) of the shade fabric 512. For example, if the width W_{FLEX3} of each lift band 720A, 720B is approximately 8 inches, each lift band will have a lift capacity of approximately 100 lbs. If the width W_{FLEX3} of each lift band 720A, 720B is approximately 6 inches, the total width of the flexible material of the lift bands adjacent the rear surface 519 of the shade fabric 512 is approximately 12 inches. Therefore, the total width of the flexible material of the lift bands 720A, 720B adjacent the rear surface 519 of the shade fabric 512 is at least three-eighths of the width W_{ROMAN3} of the shade fabric (i.e., at least 37.5% of the shade fabric).

If the lift bands 720A, 720B are made from a solid material (rather than the mesh material 120A), the minimum width W_{FLEX3} of each of the lift bands 720A, 720B may be decreased lower than approximately 6 inches. To avoid tangling of the lift bands 720A, 720B and the need to use one or more spools on the roller tube 122, the width W_{FLEX3} of each lift band 720A, 720B should be at least greater than or equal to the diameter of the roller tube. For example, if the roller tube 122 has a diameter of 1.275 inches, the width W_{FLEX3} of each lift band 720A, 720B should be at least greater than or equal to approximately 1.275 inches. However, the lift bands 720A, 720B could still be vulnerable to folding during raising and lowering of the shade fabric 512. The resulting width of a folded lift band could end up being half of the actual width W_{FLEX3}, and thus the folded lift band could be susceptible to tangling. Therefore, the width W_{FLEX3} of each of the lift bands 720A, 720B should be greater than or equal to approximately three inches.

In order to use a wider shade fabric 112 with the roman shade system 700 of the seventh embodiment, additional columns of eyelets 125 and lift bands could be provided. For example, the lift bands could be spaced approximately 10-16 inches apart along the external battens 124. In addition, rather than including the external battens 124, the roman shade system 700 could simply include columns of enlarged eyelets (not shown) connected to the internal battens 562 through which the lift bands 720A, 720B could be slidingly received.

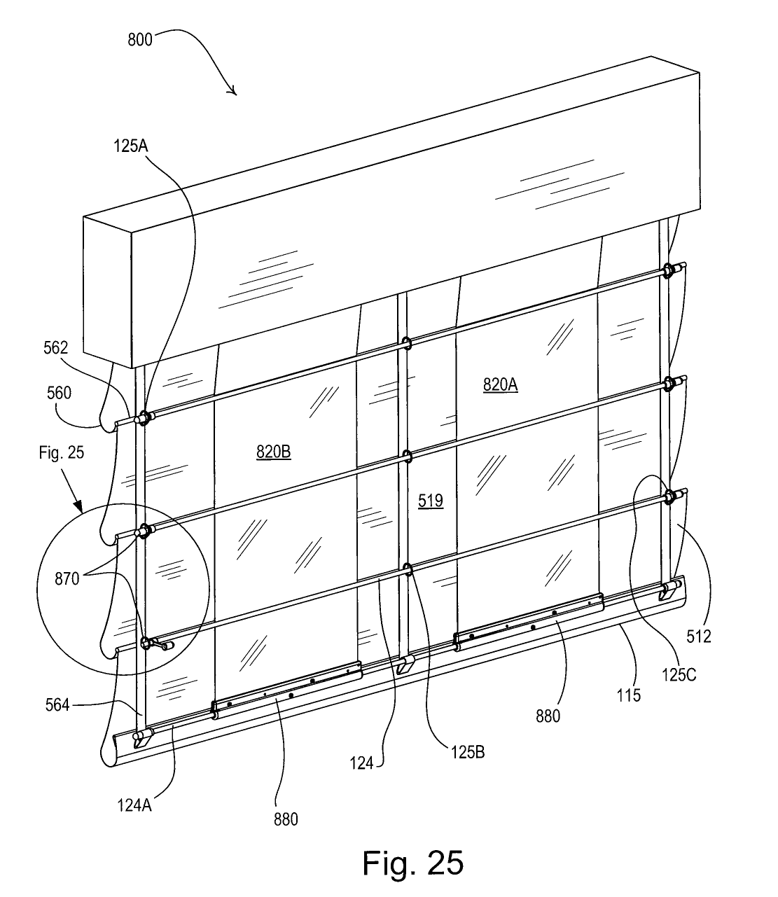

FIG. 25 is a rear perspective view of a roman shade system 800 according to an eighth embodiment of the present invention. The roman shade system 800 comprise two lift bands 820A, 820B and three columns of eyelets 125A, 125B, 125C. The roman shade system 800 comprises end caps 870 at the ends of the external battens 124 for attaching the external battens to the outermost eyelets 125A, 125C and holding the external battens adjacent the respective internal battens 562. In addition, the roman shade system 800 further comprises two band clamps 880 at the lower ends of the respective lift bands 820A, 820B for attaching the lift bands to the lowermost external batten 124A.

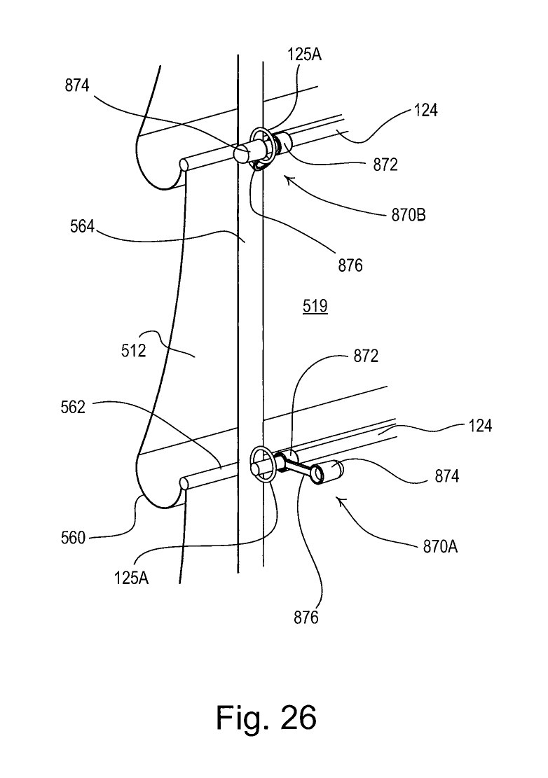

FIG. 26 is an enlarged perspective view of a portion of the roman shade system 800 showing the end caps 870 in greater detail. A first end cap 870A is shown in an unattached state, while a second end cap 870B is shown in an attached state. Each end cap 870 comprises a sleeve portion 872 and a cup portion 874 connected together by a flexible portion 876. To install one of the end caps 870 onto the end of the respective external batten 124, the sleeve portion 872 is slid around the end of the external batten, such that the external batten extends through the sleeve portion. The external batten 124 is then inserted through the respective eyelet (e.g., eyelet 125A), such that the sleeve portion 872 of the end cap 870 is located towards the interior of the roman shade system 800. The flexible portion 876 of the end cap 870 is then bent and the cup portion 874 is attached to the end of the external batten 124, such that the end of the external batten is received within the cup portion. Accordingly, the respective eyelet 125A is captured within the opening formed by the sleeve portion 872, the flexible portion 876, and the cup portion 874 of the end cap 870 and the external batten 124.

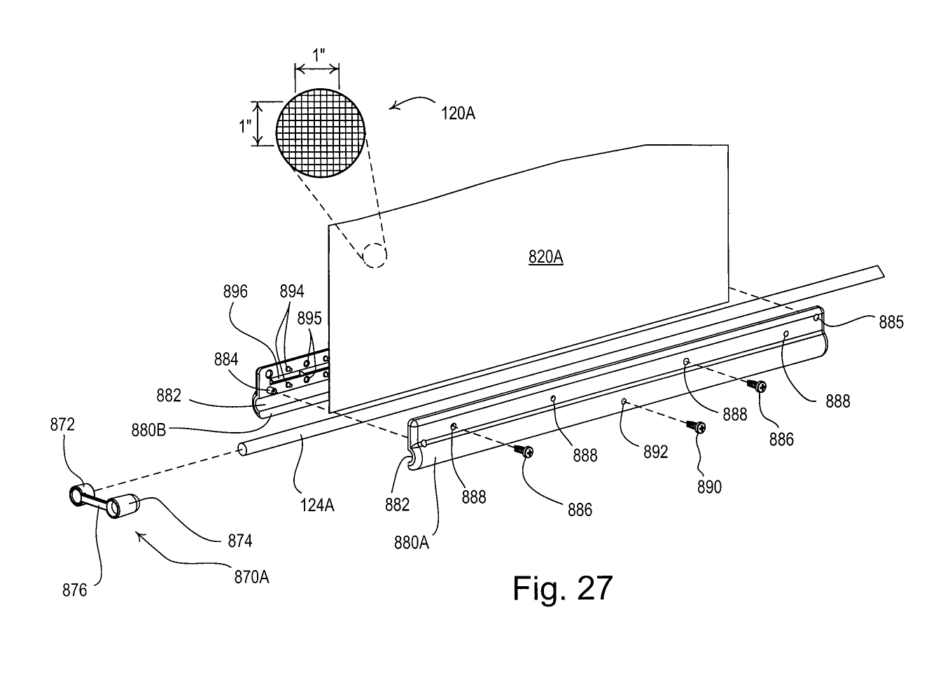

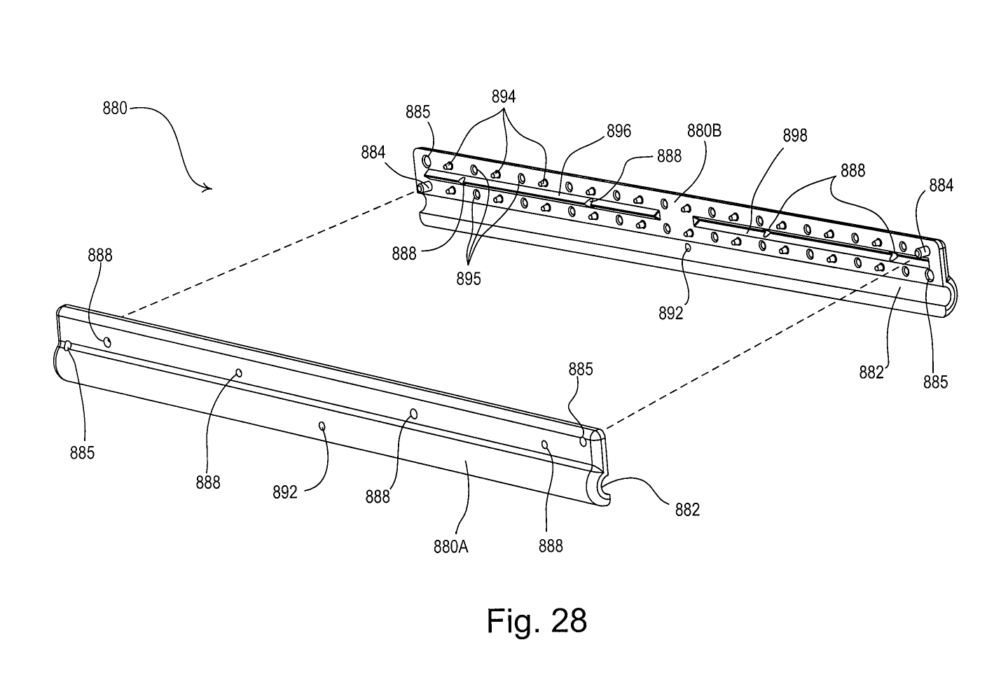

FIG. 27 is an exploded perspective view of a portion of the roman shade system 800 showing how the band clamps 880 are attached to the lift bands 820A, 820B and the lower external batten 124A. Each band clamp 880 comprises two band clamp portions 880A, 880B, which are identical to each other. FIG. 28 is an enlarged perspective view of one of the band clamps 880 of the roman shade system 800 showing the two band clamp portions 880A, 880B in greater detail. When the two band clamp portions 880A, 880B are attached together, one of the lift bands 820A, 820B is captured between the two band clamp portions. The lower external batten 124A is received within a batten channel 882 of each of the two band clamp portions 880A, 880B. Alignment pins 884 are received within alignment pin openings 885 and operate to align the two band clamp portions 880A, 880B with respect to each other when the band clamp portions are being attached together. Attachment screws 886 are received within attachment openings 888 of each of the band clamp portions 880A, 880B to fixedly hold the band clamp portions together. A set screw 890 is received through a set screw opening 892, such that the set screw contacts the lower external batten 124A inside the batten channels 882. The set screw 890 prevents horizontal movement of the band clamp 880 with respect to the lower external batten 124A when the set screw is tightened to contact the lower external batten.

The two band clamp portions 880A, 880B comprise teeth 894, which are received in pockets 895 when the band clamp portions are attached together. The teeth 894 extend through the openings formed between the strands of the mesh material 120A of the lift bands 820A, 820B. The teeth 894 help to align the band clamp portions 880A, 880B with respect to the lift bands 820A, 820B when the band clamp 880 is being attached to the lower end of the lift bands. The two band clamp portions 880A, 880B also comprise ridges 896, which are received in valleys 898 when the band clamp portions are attached together. The ridges 896 and valleys 898 operate to pinch the lift bands 820A, 820B between the two band clamp portions 880A, 880B to prevent vertical movement of the lift bands with respect to the band clamp 880 while the roman shade system 800 is raising the roman shade fabric 812. Accordingly, the two band clamps 880 of the roman shade system 800 (i.e., attached to the lift bands 820A, 820B) may be aligned with respect to each other by unscrewing the attachment screws 886 of one of the band clamps, readjusting the lift band with respect to the teeth 894, aligning the one band clamp with respect to the other band clamp, and reattaching the two band clamp portions 880A, 880B together once again.

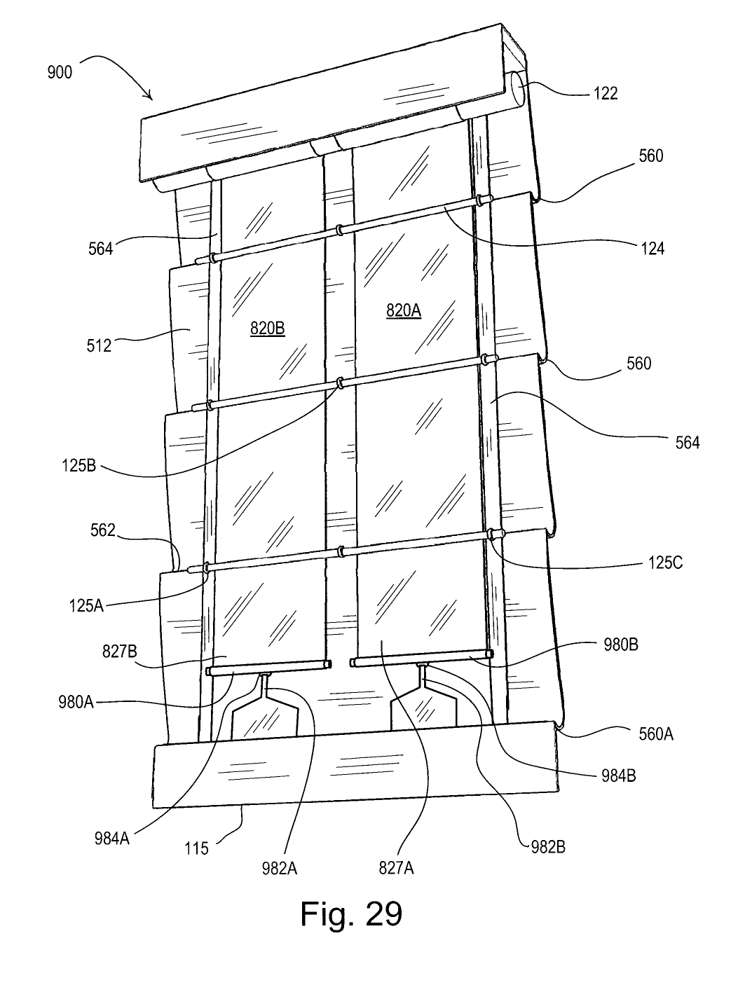

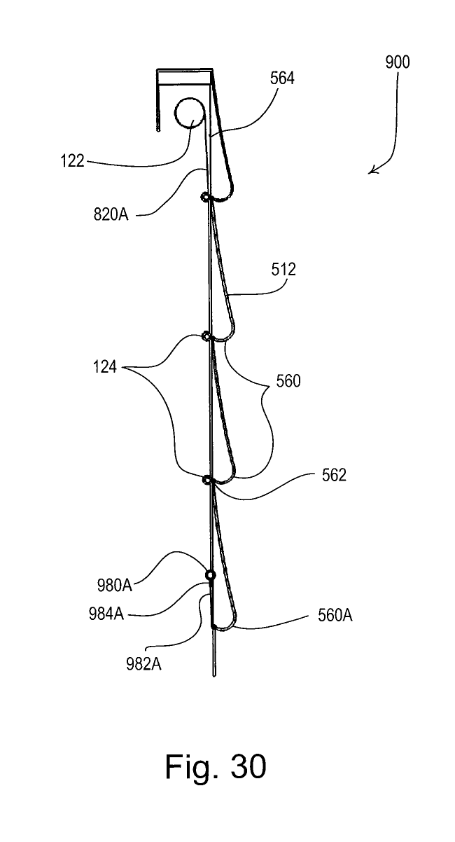

FIG. 29 is a rear perspective view and FIG. 30 is a left side view of a roman shade system 900 according to a ninth embodiment of the present invention. The bottom ends 827A, 827B of the respective lift bands 820A, 820B are attached to respective adjustable lift band attachment mechanisms 980A, 980B. Since the distances between the roller tube 122 and the bottom ends 827A, 827B of the respective lift bands 820A, 820B may not be exactly the same, the lift band attachment mechanisms 980A, 980B of the ninth embodiment of the present invention allow for easy and independent adjustment of the amount of the respective lift band that extends between the roller tube and the respective lift band attachment mechanism. The roman shade system 900 comprises two attachment flaps 982A, 982B connected to the roman shade fabric 512 near the bottom end 115 of the shade fabric. The attachment flaps 982A, 982B are each received through a respective attachment loop 984A, 984B on each of the adjustable lift band attachment mechanisms 980A, 980B to allow for attachment of the parallel sections 820A, 820B of flexible material to the lower end of the roman shade fabric 512. As the roller tube 122 is rotated such that the lift bands 820A, 820B wrap around the roller tube, the lift band attachment mechanisms 980A, 980B are pulled in an upward direction to cause the shade fabric 512 to move towards the fully open position.

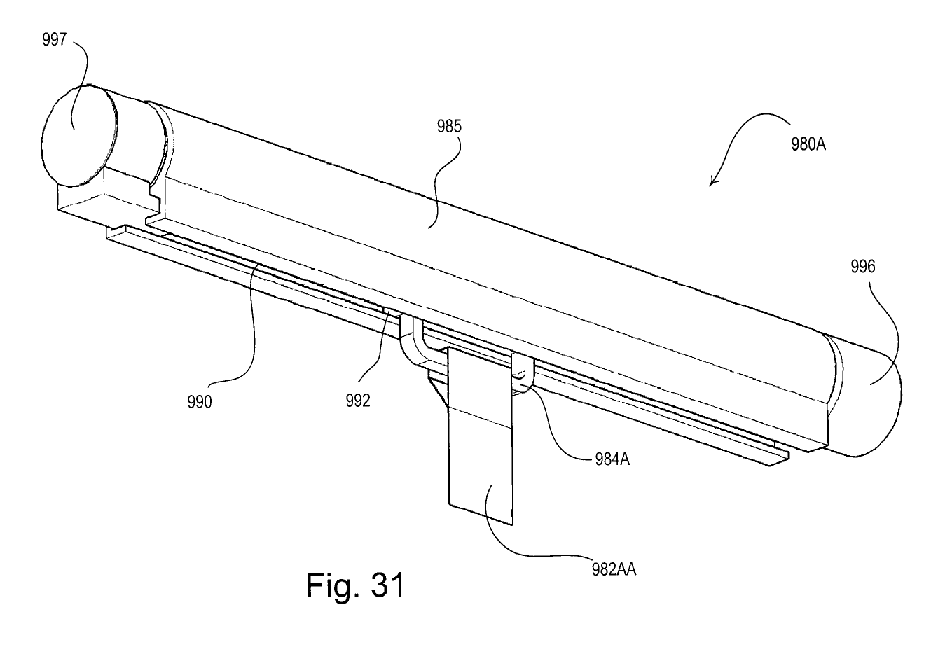

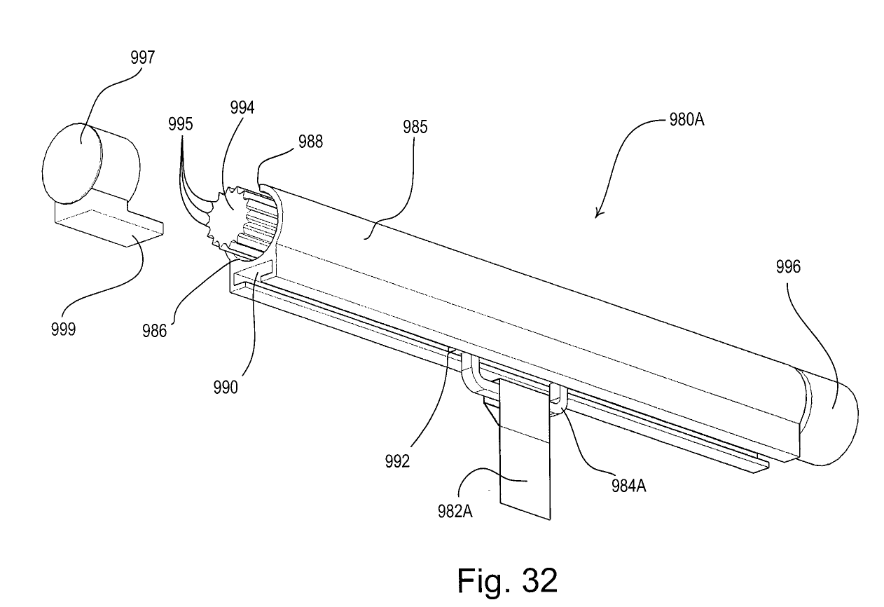

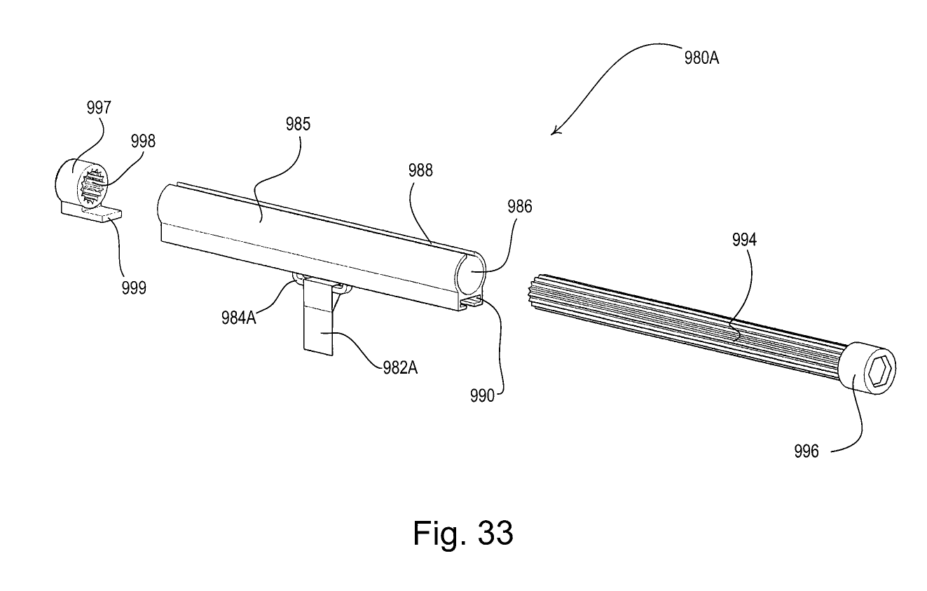

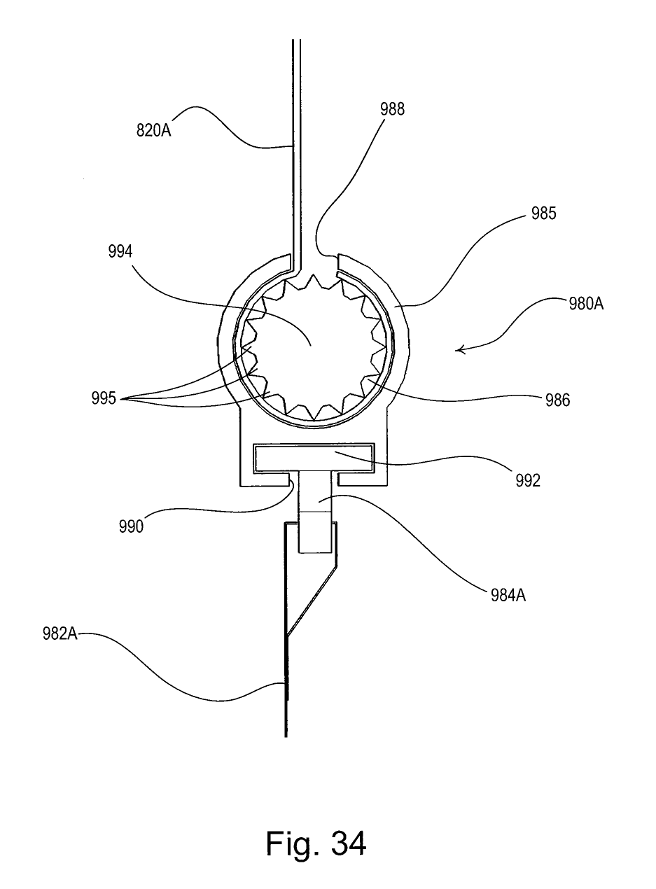

FIG. 31 is an enlarged bottom perspective view of one of the lift band attachment mechanisms 980A. FIG. 32 is a partially-exploded bottom perspective view and FIG. 33 is a partially-exploded top view of the lift band attachment mechanism 980A. FIG. 34 is a right side cross-sectional view of the lift band 820A, the lift band attachment mechanism 980A, the attachment loop 984A, and the attachment flap 982A taken through the center of the lift band attachment mechanism 980A. The lift band attachment mechanism 980A comprises an outer enclosure 985 having an elongated, cylindrical cavity 986 (FIG. 33) and an elongated opening 988 (FIG. 33), which allows for receipt of the lift band 820A into the cavity as shown in FIG. 34. The outer enclosure 985 also comprises a slot 990 arranged on the side of the outer enclosure opposite the opening 988 into the cavity 986. The slot 990 allows for sliding receipt of a base 992, which is connected to the attachment loop 984A, such that the attachment loops extends through the slot. When the lift band 820A is received through the opening 988 into the cavity 986 of the outer enclosure 985, the base 992 may be moved along the length of the slot 990 to allow for alignment of the attachment loop 984A and the attachment flap 982A of the roman shade fabric 512.

An elongated ratchet bar 994 is received within the cavity 986 of the outer enclosure 985, and comprises a plurality of teeth 995 that extend for the length of the ratchet bar. The lift band 820A is adapted to be received between the ratchet bar 994 and the inside wall of the cavity 986 of the outer enclosure 985. The teeth 995 of the ratchet bar 994 bite into the lift band 820A to hinder the movement of the lift band. A rotating endcap 996 is fixedly attached to one end of the ratchet bar 994 and allows for rotating the ratchet bar inside of the cavity. When the rotating endcap 996 is rotated, the teeth 995 of the ratchet bar 994 engage the lift band 820A and allow for movement of the lift band with respect to the outer enclosure 985.

A locking structure, e.g., locking endcap 997, is adapted to be attached to the end of the ratchet bar 994 opposite the rotating endcap 996. The locking endcap 997 comprises a mating opening 998 (FIG. 33) shaped to fit over the end of the ratchet bar 994 and a locking tab 999 adapted to fit in the slot 990 of the outer enclosure 985. When the locking endcap 997 is coupled between the outer enclosure 985 and the ratchet bar 994, the ratchet bar is fixed in position with respect to the outer enclosure and is not able to rotate inside of the cavity 986. Thus, the lift band 820A is fixed in position with respect to the outer enclosure 985.

The roman shade system 900 may be installed by first mounting the roller tube 122 and suspending the lift bands 820A, 820B from the roller tube. The roman shade fabric 512 may then be mounted to hang adjacent the lift bands 820A, 820B, and the lift bands are slid between the internal battens 562 and the external battens 114. Next, the lift bands 820A, 820B are inserted into the openings 988 of the lift band attachment mechanisms 980A, 980B, and the attachment flaps 982A, 982B of the shade fabric 512 are attached to the respective attachment loops 984A, 984B. The rotating endcaps 996 of each of the lift band attachment mechanisms 980A, 980B may then be rotated until the two lift band attachment mechanisms are aligned. Finally, the locking endcaps 997 of each of the lift band attachment mechanisms 980A, 980B are installed, and the roman shade system 900 is ready for operation. Accordingly, the lift band attachment mechanisms 980A, 980B allow for easy fine tune adjustment of the lengths of the lift bands 820A, 820B.

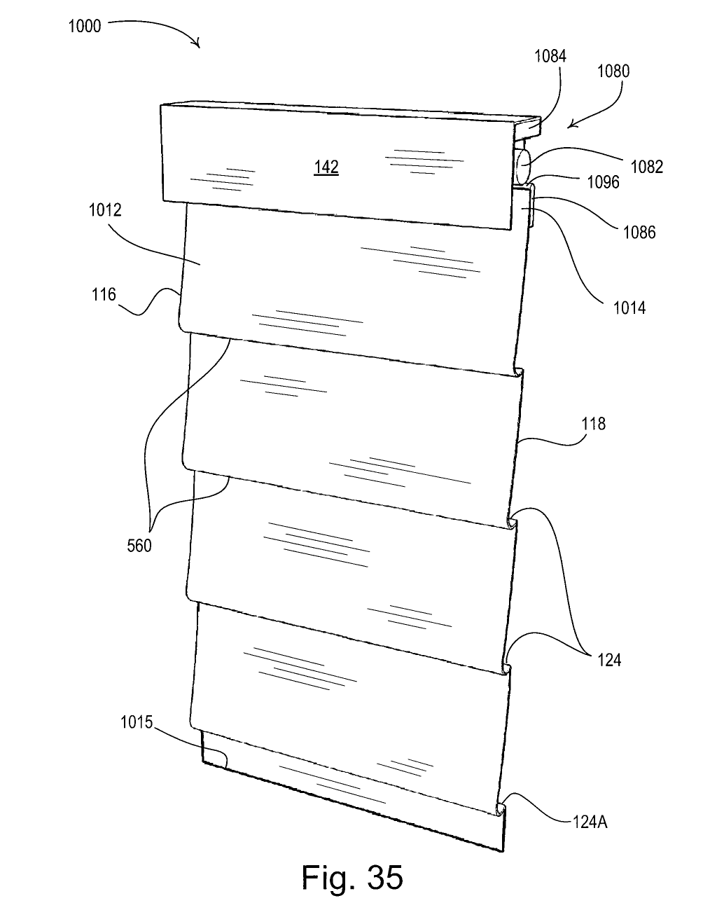

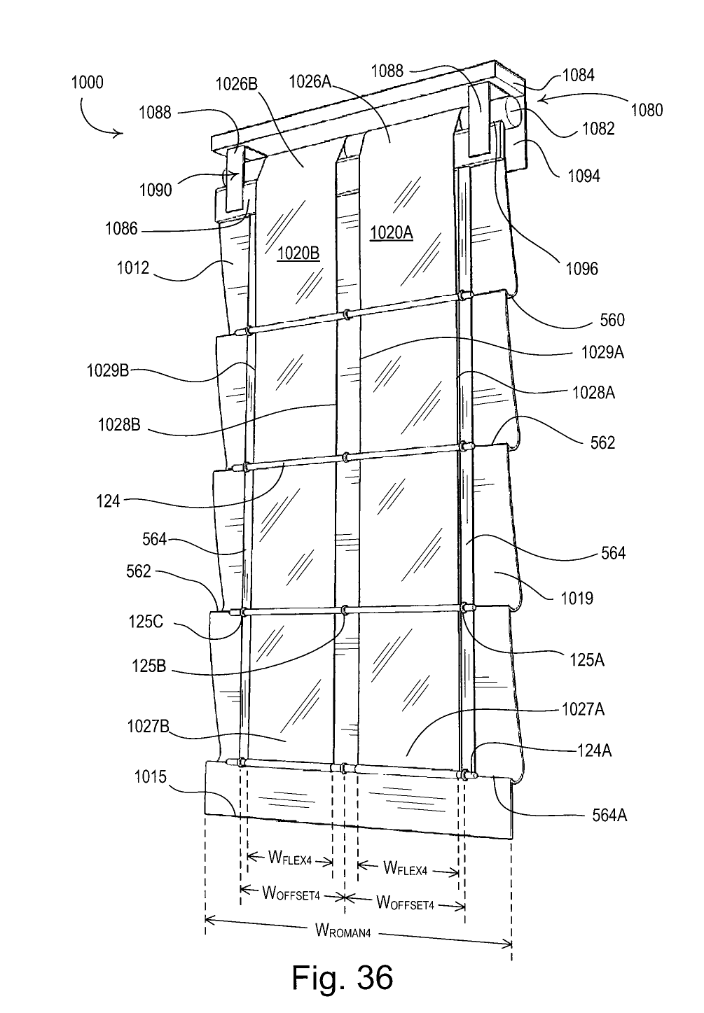

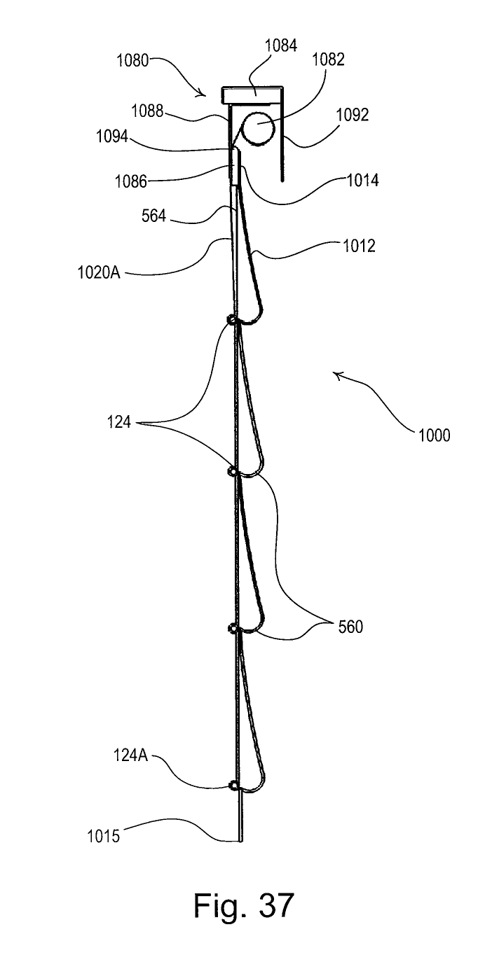

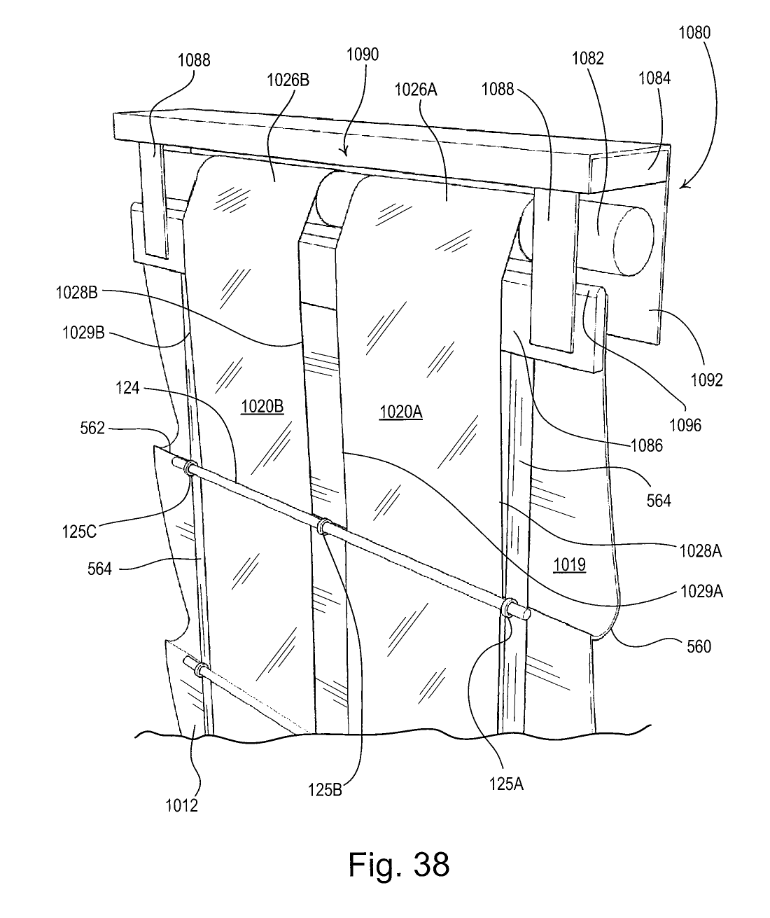

FIG. 35 is a rear perspective view of a roman shade system 1000 having a front control assembly 1080 according to a tenth embodiment of the present invention. FIG. 36 is a rear perspective view and FIG. 37 is a left side view of the roman shade system 1000. FIG. 38 is an enlarged rear perspective view of the roman shade system 1000 of the tenth embodiment. The roman shade system 1000 has a hobbled roman shade fabric 1012 that extends from a top end 1014 to a bottom end 1015.

The front control assembly 1080 includes a roller tube 1082 mounted in front of the roman shade fabric 1010 (as shown in FIG. 37), such that the shade fabric may be placed as close as possible to the window that the shade fabric is covering. The front control assembly 1080 also comprises a mounting structure 1084, which may be mounted to a wall above the window, a ceiling above the window, or walls on each side of the window. The roller tube 1082 may be rotatably mounted to the mounting structure 1084 or the walls or ceiling around the mounting structure. The front control assembly 1080 further comprises a support member (e.g., a support bar 1086) to which the top end 1014 of the roman shade fabric 1012 is attached. The support bar 1086 is connected to the mounting structure 1084 via two attachment bars 1088, such that a gap 1090 is created between the mounting structure and the support bar. A valance fabric 1092, which may be made from the same material as the shade fabric 1012, is connected to the mounting structure 1084 and hangs in front of the roller tube 1082 to hide the front control assembly 1080 from view of a user of the roman shade system 1000.

The roman shade system 1000 comprises two lift bands 1020A, 1020B, which each have, respectively, a first end 1026A, 1026B, a second end 1027A, 1027B, and two opposing side edges 1028A, 1029A, 1028B, 1029B. The lift bands 1020A, 1020B extend from the lowest batten 124A to the roller tube 1082 along a rear surface 1019 of the shade fabric 1012, i.e., out of sight from the user. The first ends 1026A, 1026B of the lift bands 1020A, 1020B are connected to the roller tube 1022, while the second ends 1027A, 1027B are connected to the roman shade fabric 1012 adjacent a bottom end 1015 of the roman shade fabric 1012. The lift bands 1020A, 1020B are windingly received around the roller tube 1082 and are slidingly received between the external battens 124 and the internal battens 562. The lift bands 1020A, 1020B extend through the gap 1090 formed between the mounting structure 1084 and the support bar 1086 of the front control assembly 1080 and are draped across a rounded top surface 1096 (e.g., a rounded top edge) of the support bar. The second ends 1027A, 1027B and thus the bottom end 1015 of the shade fabric 1012 are adapted to move in the upward direction and in the downward direction as the roller tube is rotated in respective first and second directions, so as to respectively raise and lower the roman shade fabric.

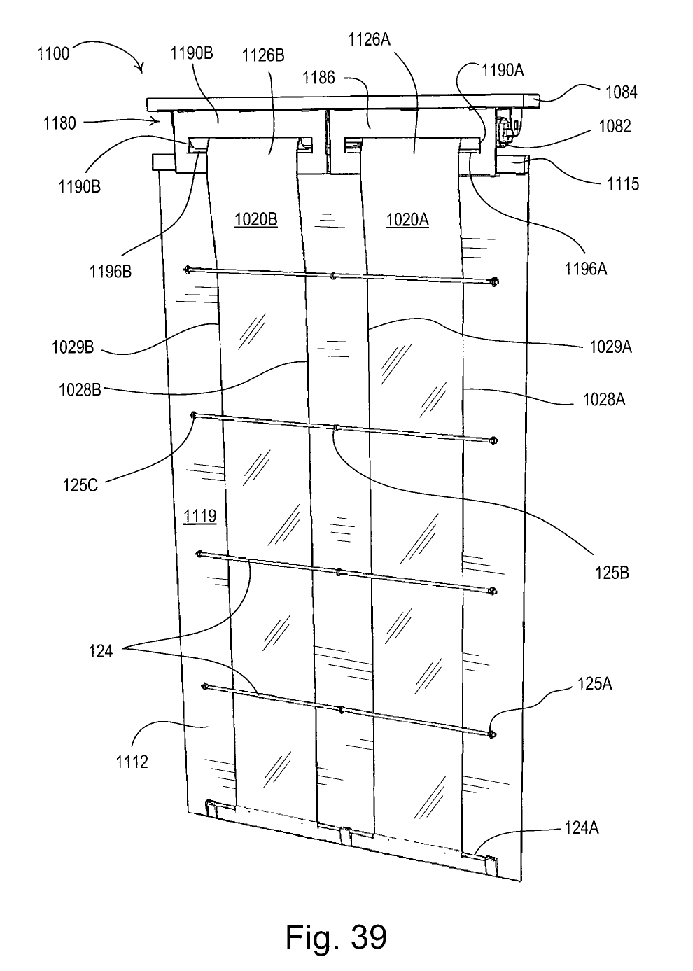

FIG. 39 is a rear perspective view of a roman shade system 1100 having a front control assembly 1180 and a flat roman shade fabric 1112 according to an eleventh embodiment of the present invention. The front control assembly 1180 of the second embodiment comprises two support members 1184A, 1184B for each of the lift bands 1020A, 1020B, respectively. Specifically, each of the support members 1184A, 1184B comprises a respective lift band opening 1190A, 1190B, through which the respective lift band 1020A, 1020B is slidingly received. Each of the lift bands 1020A, 1020B is draped across a respective rounded surface 1196A, 1996B (e.g., a rounded lower edge) of the respective lift band opening 1190A, 1190B through which the lift band extends. A top end 1115 of the roman shade fabric 1112 is connected to both of the support members 1184A, 1184B below the openings 1190A, 1190B, such that the lift bands 1020A, 1020B are able to extend from the lowest batten 124A to the roller tube 1022 along a rear surface 1119 of the shade fabric 1112. While not shown in FIG. 39, a valance fabric may be connected to the mounting structure 1084 to hang in front of the roller tube 1082 and hide the front control assembly 1180 from view of a user of the roman shade system 1100.

While the roman shade systems 600, 700, 800, 900, 1000 shown in FIGS. 21-39 comprise hobbled roman shade fabrics, the roman shade systems of the sixth, seventh, eighth, ninth, and tenth embodiments could also comprise flat roman shade fabrics (as in the first embodiment) or knife-fold roman shade fabrics (as in the fourth embodiment). Further, the concepts of the present invention could also be applied to other types of window treatment fabrics that are adapted to be raised and lowered in front of a window or opening, such as, for example, a pleated shade fabric or a venetian blind.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A shade system comprising:
a shade fabric having a top end and a bottom end, the shade fabric adapted to move between a fully-open position and a fully-closed position;
a rotatably-mounted roller tube mounted adjacent the top end of the shade fabric;
a flexible material windingly received around the roller tube and extending from the roller tube to the bottom end of the shade fabric, the flexible material having a first end connected to the roller tube and a second end opposite the first end; and
a plurality of coupling structures for holding the flexible material adjacent to a rear surface of the shade fabric, each of the coupling structures attached to the rear surface of the shade fabric at attachment points that are spaced apart by an offset distance, such that the coupling structures and the shade fabric form openings for receiving the flexible material;
wherein the flexible material is slidingly received through the openings formed by the coupling structures and the shade fabric, the flexible material having a width that is slightly less than the offset distance and positioned between the attachment points at which the coupling structures are connected to the rear surface of the shade fabric, the second end of the flexible material coupled to the shade fabric adjacent the bottom end of the shade fabric, such that the bottom end of the shade fabric is adapted to move in an upward direction and in a downward direction as the roller tube is rotated in respective first and second directions.

2. The shade system of claim 1, wherein the shade fabric has two opposing side edges, the attachment points of the coupling structures located adjacent to the side edges of the shade fabric.

3. The shade system of claim 2, wherein each of the coupling structures comprises an elongated rigid member extending horizontally across the rear surface of the shade fabric.

4. The shade system of claim 3, wherein each elongated rigid member comprises an external batten.

5. The shade system of claim 4, wherein each of the coupling structures further comprises two eyelets located at the attachment points of the coupling structure, each of the external battens received through the eyelets, such that the external battens extend for at least the offset distance between the eyelets.

6. The shade system of claim 5, further comprising:
a plurality of internal battens extending horizontally across and sewn into the rear surface of the shade fabric, each of the internal battens located parallel and adjacent to one of the external battens, the flexible material slidingly received between the respective internal and external battens.

7. The shade system of claim 6, further comprising:
two ribbons extending from the top end to the bottom end of the shade fabric and attached to each of the internal battens, the length of each of the ribbons between two adjacent internal battens being less than the length of the shade fabric between the two adjacent internal battens, such that the shade fabric hangs with folds as the shade system moves towards the fully-open position.

8. The shade system of claim 7, wherein the shade fabric comprises a hobbled roman shade fabric.

9. The shade system of claim 5, further comprising:
a plurality of fold-forming battens extending horizontally across the rear surface of the shade fabric, a portion of the shade fabric looping through each of the fold-forming battens, each of the fold-forming battens located parallel and adjacent to one of the external battens, the flexible material slidingly received between the fold-forming battens and the external battens.

10. The shade system of claim 9, wherein the shade fabric comprises a knife-fold roman shade fabric.

11. The shade system of claim 5, wherein each of the coupling structures further comprises an additional eyelet located between the other two eyelets, the respective batten received through the additional eyelet for support around the center of the batten, the flexible material comprising two parallel sections of flexible material positioned between the eyelets, such that the additional eyelet is located between the two parallel sections of flexible material.

12. The shade system of claim 5, wherein the shade fabric comprises a flat roman shade fabric.

13. The shade system of claim 5, wherein a width of the flexible material is approximately two inches less than the offset distance.

14. The shade system of claim 5, further comprising:
an end cap coupled to the end of one of the external battens, the endcap comprising a sleeve portion, a cup portion, and a flexible portion connected between the sleeve portion and the cup portion, the external batten extending through the sleeve portion and received in the cup portion, such that one of the eyelets is captured by the opening formed by the sleeve portion, the flexible portion, and the cup portion of the end cap and the external batten.

15. The shade system of claim 4, wherein each of the coupling structures further comprises two pockets sewn onto the rear surface of the shade fabric at the attachment points of the coupling structure, the ends of each batten inserted into the respective pockets, such that the battens extend for at least the offset distance between the pockets.

16. The shade system of claim 4, wherein each of the coupling structures comprises a pair of fingers, the fingers extending towards each other and arranged to form the opening for receiving the flexible material, each pair of fingers operable to partially surround the flexible material and hold the flexible material adjacent the rear surface of the shade fabric.

17. The shade system of claim 2, wherein the flexible material comprises a flexible sheet.

18. The shade system of claim 17, wherein a width of the flexible material is at least approximately 50% of a width of the shade fabric.

19. The shade system of claim 18, wherein a width of the flexible material is at least approximately 70% of a width of the shade fabric.

20. The shade system of claim 17, wherein the flexible sheet comprises a roller shade fabric.

21. The shade system of claim 2, wherein the flexible material comprises a mesh material.

22. The shade system of claim 2, wherein each of the coupling structures comprises an elongated piece of shade fabric material sewn to the rear surface of the shade fabric at the attachment points, the flexible material slidingly received between the elongated pieces of shade fabric material and the shade fabric.

23. The shade system of claim 2, wherein each of the coupling structures comprises a pair of fingers, the fingers extending towards each other and arranged to form the opening for receiving the flexible material, each pair of fingers operable to partially surround the flexible material and hold the flexible material adjacent the rear surface of the shade fabric.

24. The shade system of claim 2, further comprising:
a plurality of elongated battens extending horizontally across the rear surface of the shade fabric; and
a plurality of eyelets located at the attachment points at which the battens are connected to the rear surface of the shade fabric, each of the battens received through two of the eyelets;
wherein each of the coupling structures comprises a band guide positioned adjacent each of the respective battens, each band guide coupled between the two eyelets through which the respective batten is received, such that the flexible material is slidingly received in the opening formed between the band guide and the respective batten.

25. The shade system of claim 2, wherein the shade fabric comprises a roman shade fabric and is adapted to form a plurality of horizontal pleats as the shade fabric moves towards the fully-open position.

26. The shade system of claim 1, wherein the shade fabric is adapted to cover an opening, the shade system further comprising:
a support bar mounted between the roller tube and the opening, the top end of the shade fabric fixedly attached to the support bar, the flexible material draped across a top edge of the support bar to extend from the bottom end of the shade fabric to the roller tube.

27. A roman shade system comprising:
a roman shade fabric having a top end, a bottom end opposite the top end, and two opposing side edges, the roman shade fabric adapted to move between a fully-open position and a fully-closed position, the roman shade fabric adapted to form a plurality of horizontal pleats as the shade fabric moves towards the fully-open position;
a rotatably-mounted roller tube mounted adjacent the top end of the roman shade fabric;
a lift band windingly received around the roller tube, the lift band comprising a flexible material having a first end connected to the roller tube and a second end opposite the first end, the second end of the lift band connected to the roman shade fabric adjacent a bottom edge of the roman shade fabric; and
a plurality of elongated rigid members extending horizontally across a rear surface of the roman shade fabric, each of the rigid members attached to the rear surface of the roman shade fabric at attachment points that are located adjacent to the side edges of the roman shade fabric and are spaced apart by an offset distance;
wherein the lift band is slidingly received between the elongated rigid members and the shade fabric for holding the lift band adjacent to the rear surface of the roman shade fabric, the lift band having a width that is slightly less than the offset distance and positioned between the attachment points at which the elongated rigid members are connected to the rear surface of the shade fabric, the second end of the lift band adapted to move in an upward direction and in a downward direction as the roller tube is rotated in respective first and second directions, so as to respectively raise and lower the shade fabric.

28. The roman shade system of claim 27, wherein the elongated rigid members comprise battens.

29. The roman shade system of claim 28, further comprising:
a plurality of eyelets located at the attachment points at which the battens are connected to the rear surface of the shade fabric;
wherein each of the battens is received through the eyelets, such that the battens extend for at least the offset distance between the eyelets.

30. The roman shade system of claim 27, further comprising a second lift band windingly received around the roller tube and extending parallel to the other lift band.

31. The roman shade system of claim 27, wherein the lift band comprises a mesh material.

32. A roman shade system comprising:
a roman shade fabric having a top end, a bottom end opposite the top end, and first and second opposing side edges, the shade fabric adapted to move between a fully-open position and a fully-closed position, the roman shade fabric adapted to form a plurality of horizontal pleats as the shade fabric moves towards the fully-open position;
a rotatably-mounted roller tube mounted adjacent the top end of the roman shade fabric;
at least two lift bands windingly received about the roller tube and arranged parallel to each other, the lift bands extending from the roller tube to the bottom end of the roman shade fabric; and
a plurality of coupling structures for holding the lift bands adjacent to a rear surface of the roman shade fabric, each of the coupling structures attached to the rear surface of the roman shade fabric at attachment points that are spaced apart by an offset distance, such that the coupling structures and the shade fabric form openings for receiving the lift bands;
wherein the lift bands are slidingly received through the openings formed by the coupling structures and the roman shade fabric, each of the lift bands having a width greater than or equal to approximately six inches, the lift bands coupled to the bottom end of the roman shade fabric, such that the bottom end of the roman shade fabric is adapted to move in an upward direction and in a downward direction as the roller tube is rotated in respective first and second directions, so as to respectively raise and lower the roman shade fabric.

33. The roman shade system of claim 32, wherein the lift bands each comprise a flexible mesh material.

34. The roman shade system of claim 33, wherein the mesh material comprises a leno weave having warp yarns oriented vertically and comprising two strands twisted together, and fill yarns oriented horizontally and comprising a single strand.

35. The roman shade system of claim 34, wherein the mesh material is made from polyester strands having diameters of approximately 0.003 inches.

36. The roman shade system of claim 35, wherein the mesh material has approximately nine warp yarns and eighteen fill yarns in one square inch of the mesh material.

37. The roman shade system of claim 33, wherein the mesh material is made from fiberglass strands having diameters of approximately 0.005 inches.

38. The roman shade system of claim 37, wherein the mesh material has approximately eight vertical strands and eight horizontal strands in one square inch of the mesh material.

39. The roman shade system of claim 37, wherein the fiberglass strands of the mesh material are coated with polyvinyl chloride.

40. The roman shade system of claim 32, further comprising:
an adjustable lift band attachment mechanism coupled to a lower end of a first one of the lift bands and the bottom end of the shade fabric for attaching the first lift band to the shade fabric.

41. The roman shade system of claim 40, wherein the first lift band attachment mechanism comprises:
an outer enclosure having an elongated, cylindrical cavity and an elongated opening allowing for receipt of the first lift band into the cavity;
an elongated ratchet bar received within the cavity of the outer enclosure, such that the first lift band may be positioned between the ratchet bar and the outer enclosure; and
a locking structure adapted to be coupled to both the ratchet bar and the outer enclosure to fix the ratchet bar in position with respect to the outer enclosure;
wherein, when the locking structure is not coupled to both the ratchet bar and the outer enclosure, the ratchet bar is adapted to be rotated to adjust the amount of the first lift band that is received within the cavity, and when the locking structure is coupled to both the ratchet bar and the outer enclosure, the ratchet bar and the first lift band are fixed in position with respect to the outer enclosure.

42. The roman shade system of claim 41, wherein the ratchet bar comprises a plurality of teeth that extend for the length of the ratchet bar, the teeth adapted to bite into the first lift band when the first lift band is received between the ratchet bar and the outer enclosure, the lift band attachment mechanism further comprising a rotating endcap fixedly attached to one end of the ratchet bar to provide for rotating the ratchet bar to adjust the amount of the first lift band that is received within the cavity when the locking structure is not coupled to both the ratchet bar and the outer enclosure.

43. The roman shade system of claim 42, wherein the locking structure comprises a locking endcap having a mating opening shaped to fit over one end of the ratchet bar to prevent rotation of the ratchet bar, such that the first lift band is fixed in position with respect to the outer enclosure.

44. The roman shade system of claim 41, wherein the lift band attachment mechanism further comprises an attachment loop connected to a base and adapted to be coupled to an attachment flap of the shade fabric, the outer enclosure comprising a slot opposite the elongated opening, the slot operable to slidingly receive the base, such that the attachment loop extends through the slot and is operable to be moved along the length of the slot to allow for alignment of the attachment loop and the attachment flap.

45. The roman shade system of claim 40, further comprising a second adjustable lift band attachment mechanism coupled to a lower end of a second one of the lift bands and the bottom end of the shade fabric for attaching the second one of the lift bands to the shade fabric.

46. The roman shade system of claim 32, wherein each of the coupling structures comprises an elongated batten extending horizontally across the rear surface of the shade fabric.

47. The roman shade system of claim 46, further comprising:
a band clamp coupled to a lower end of a first one of the lift bands and a lowermost one of the external battens for attaching the first lift band to the lowermost external batten.

48. The roman shade system of claim 47, wherein the band clamp comprises two portions having ridges that operate to pinch the first lift band when the portions are connected together to prevent vertical movement of the first lift band with respect to the band clamp.

49. The roman shade system of claim 48, wherein the first lift band comprises a flexible mesh material, and the two portions of the band clamp have teeth that extend through openings in the mesh material when the two portions are connected together.

50. The roman shade system of claim 47, wherein the band clamp comprises a batten channel for receiving the lowermost one of the external battens, and a set screw received through an opening in the band clamp for contacting the lowermost one of the external battens to prevent horizontal movement of the lowermost one of the battens.

51. The roman shade system of claim 32, wherein the width of each of the lift bands is greater than or equal to approximately eight inches.

52. The roman shade system of claim 51, wherein the lift bands each have a lift capacity of approximately 100 lbs.

53. A roman shade system comprising:
a roman shade fabric having a top end, a bottom end opposite the top end, and first and second opposing side edges, the shade fabric adapted to move between a fully-open position and a fully-closed position, the roman shade fabric adapted to form a plurality of horizontal pleats as the shade fabric moves towards the fully-open position;
a rotatably-mounted roller tube mounted adjacent the top end of the roman shade fabric;
at least two sections of mesh material arranged parallel to each other and extending from the roller tube to the bottom end of the roman shade fabric, the sections of mesh material coupled to the bottom end of the roman shade fabric and windingly received about the roller tube; and
a plurality of coupling structures for holding the two sections of mesh material adjacent to a rear surface of the roman shade fabric, each of the coupling structures attached to the rear surface of the roman shade fabric at attachment points that are spaced apart by an offset distance, such that the coupling structures and the shade fabric form openings for receiving the sections of mesh material;
wherein the sections of mesh material are slidingly received through the openings formed by the coupling structures and the roman shade fabric, each of the sections of mesh material having a width greater than or equal to approximately six inches, the bottom end of the roman shade fabric adapted to move in an upward direction and in a downward direction as the roller tube is rotated in respective first and second directions, so as to respectively raise and lower the roman shade fabric.

54. The roman shade system of claim 53, wherein the width of each section of mesh material is greater than or equal to approximately eight inches.

55. The roman shade system of claim 54, wherein each section of mesh material has a lift capacity of approximately 100 lbs.

56. The roman shade system of claim 53, wherein each section of mesh material comprises a leno weave having warp yarns oriented vertically and comprising two strands twisted together, and fill yarns oriented horizontally and comprising a single strand.

57. The roman shade system of claim 56, wherein each section of mesh material is made from polyester strands having diameters of approximately 0.003 inches, and having approximately nine warp yarns and eighteen fill yarns in one square inch.

58. The roman shade system of claim 53, wherein each section of mesh material is made from fiberglass strands coated with polyvinyl chloride and having diameters of approximately 0.005 inches, each section of mesh material having approximately eight vertical strands and eight horizontal strands in one square inch.

59. The shade system of claim 53, further comprising:
adjustable lift band attachment mechanisms coupled to lower ends of the sections of the mesh material and the bottom end of the shade fabric for attaching the sections of mesh material to the shade fabric, each lift band attachment mechanism comprising:
an outer enclosure having an elongated, cylindrical cavity and an elongated opening allowing for receipt of the respective section of mesh material into the cavity;
an elongated ratchet bar received within the cavity of the outer enclosure, such that the respective section of mesh material may be positioned between the ratchet bar and the outer enclosure; and
a locking structure adapted to be coupled to both the ratchet bar and the outer enclosure to fix the ratchet bar in position with respect to the outer enclosure;
wherein, when the locking structure is not coupled to both the ratchet bar and the outer enclosure, the ratchet bar is adapted to be rotated to adjust the amount of the respective section of mesh material that is received within the cavity, and when the locking structure is coupled to both the ratchet bar and the outer enclosure, the ratchet bar and the respective section of mesh material are fixed in position with respect to the outer enclosure.

60. The shade system of claim 59, wherein the ratchet bar of each lift band attachment mechanism comprises a plurality of teeth that extend for the length of the ratchet bar, the teeth adapted to bite into the respective section of mesh material when the section of mesh material is received between the ratchet bar and the outer enclosure, each lift band attachment mechanism further comprising a rotating endcap fixedly attached to one end of the ratchet bar to provide for rotating the ratchet bar to adjust the amount of the respective section of mesh material that is received within the cavity when the locking structure is not coupled to both the ratchet bar and the outer enclosure, the locking structure of each lift band attachment mechanism comprising a locking endcap having a mating opening shaped to fit over one end of the ratchet bar to prevent rotation of the ratchet bar, such that the respective section of mesh material is fixed in position with respect to the outer enclosure.

61. The shade system of claim 53, further comprising:
a plurality of elongated battens extending horizontally across the rear surface of the shade fabric; and
a band clamp coupled to a lower end of one of the sections of the mesh material and a lowermost one of the external battens for attaching the section of mesh material to the lowermost external batten, the band clamp comprising two portions having ridges that operate to pinch the section of mesh material when the portions are connected together to prevent vertical movement of the section of mesh material with respect to the band clamp, the band clamp further comprising a batten channel for receiving the lowermost one of the external battens, and a set screw received through an opening in the band clamp for contacting the lowermost one of the external battens to prevent horizontal movement of the lowermost one of the battens.

62. A roman shade system comprising:
a roman shade fabric having a top end, a bottom end opposite the top end, and first and second opposing side edges, the shade fabric adapted to move between a fully-open position and a fully-closed position, the roman shade fabric adapted to form a plurality of horizontal pleats as the shade fabric moves towards the fully-open position;
a rotatably-mounted roller tube mounted adjacent the top end of the roman shade fabric;
at least two sections of flexible material windingly received about the roller tube and arranged parallel to each other, the two sections of flexible material extending from the roller tube to the bottom end of the roman shade fabric; and
a plurality of coupling structures for holding the two sections of flexible material adjacent to a rear surface of the roman shade fabric, each of the coupling structures attached to the rear surface of the roman shade fabric at attachment points that are spaced apart by an offset distance, such that the coupling structures and the shade fabric form openings for receiving the sections of flexible material;
wherein the sections of flexible material are slidingly received through the openings formed by the coupling structures and the roman shade fabric, a total width of the sections of flexible material being approximately 37.5% or greater of a width of the shade fabric, the sections of flexible material coupled to the bottom end of the roman shade fabric, such that the bottom end of the roman shade fabric is adapted to move in an upward direction and in a downward direction as the roller tube is rotated in respective first and second directions, so as to respectively raise and lower the roman shade fabric.

63. The roman shade system of claim 62, wherein each of the sections of flexible material comprises a flexible mesh material.

64. The roman shade system of claim 63, wherein the width of each of the sections of flexible material is greater than or equal to approximately eight inches.

65. The roman shade system of claim 64, wherein the sections of flexible material each have a lift capacity of approximately 100 lbs.

66. A roman shade system comprising:
a roman shade fabric having a top end, a bottom end opposite the top end, and first and second opposing side edges, the shade fabric adapted to move between a fully-open position and a fully-closed position, the roman shade fabric adapted to form a plurality of horizontal pleats as the shade fabric moves towards the fully-open position;
a rotatably-mounted roller tube mounted adjacent the top end of the roman shade fabric;
at least two sections of flexible material windingly received about the roller tube and arranged parallel to each other, the section of flexible material extending from the roller tube to the bottom end of the roman shade fabric; and
a plurality of coupling structures for holding the two sections of flexible material adjacent to a rear surface of the roman shade fabric, each of the coupling structures attached to the rear surface of the roman shade fabric at attachment points that are spaced apart by an offset distance, such that the coupling structures and the shade fabric form openings for receiving the sections of flexible material;
wherein the sections of flexible material are slidingly received through the openings formed by the coupling structures and the roman shade fabric, the sections of flexible material each having a width greater than or equal to approximately three inches, the sections of flexible material coupled to the bottom end of the roman shade fabric, such that the bottom end of the roman shade fabric is adapted to move in an upward direction and in a downward direction as the roller tube is rotated in respective first and second directions, so as to respectively raise and lower the roman shade fabric.

67. The roman shade system of claim 66, wherein each of the coupling structures comprises an elongated rigid member extending horizontally across the rear surface of the shade fabric.

68. The roman shade system of claim 67, wherein each elongated rigid member comprises an external batten, the flexible material slidingly received through the openings formed by the external battens and the shade fabric.

69. The roman shade system of claim 68, wherein each of the coupling structures further comprises two eyelets located at the attachment points of the coupling structure, each of the external battens received through the eyelets, such that the external battens extend for at least the offset distance between the eyelets.

70. The roman shade system of claim 69, wherein each of the coupling structures further comprises an additional eyelet located between the two parallel sections of flexible material, the respective batten received through the additional eyelet for support around the center of the batten.

71. The roman shade system of claim 66, wherein the sections of flexible material are made from a solid material.

72. A flexible material attachment mechanism for a shade system, the flexible material attachment mechanism comprising:
an outer enclosure having an elongated, cylindrical cavity and an elongated opening allowing for receipt of a flexible material into the cavity;
an elongated ratchet bar received within the cavity of the outer enclosure, such that the flexible material may be positioned between the ratchet bar and the outer enclosure; and
a locking structure adapted to be coupled to both the ratchet bar and the outer enclosure to fix the ratchet bar in position with respect to the outer enclosure;
wherein, when the locking structure is not coupled to both the ratchet bar and the outer enclosure, the ratchet bar is adapted to be rotated to adjust the amount of the flexible material that is received within the cavity, and when the locking structure is coupled to both the ratchet bar and the outer enclosure, the ratchet bar and the flexible material are fixed in position with respect to the outer enclosure.

73. The flexible material attachment mechanism of claim 72, wherein the ratchet bar comprises a plurality of teeth that extend for the length of the ratchet bar, the teeth adapted to bite into the flexible material when the flexible material is received between the ratchet bar and the outer enclosure.

74. The flexible material attachment mechanism of claim 73, further comprising:
a rotating endcap fixedly attached to one end of the ratchet bar to provide for rotating the ratchet bar to adjust the amount of the flexible material that is received within the cavity when the locking structure is not coupled to both the ratchet bar and the outer enclosure.

75. The flexible material attachment mechanism of claim 73, wherein the locking structure comprises a locking endcap having a mating opening shaped to fit over one end of the ratchet bar to prevent rotation of the ratchet bar, such that the flexible material is fixed in position with respect to the outer enclosure.

76. The flexible material attachment mechanism of claim 72, further comprising:
an attachment loop adapted to be coupled to a shade fabric and connected to a base;
wherein the outer enclosure comprises a slot opposite the elongated opening, the slot operable to slidingly receive the base, such that the attachment loop extends through the slot.

77. The flexible material attachment mechanism of claim 76, wherein the attachment loop is adapted to be coupled to an attachment flap of the shade fabric, the attachment loop operable to be moved along the length of the slot to allow for alignment of the attachment loop and the attachment flap.

78. A shade system for covering an opening comprising:
a shade fabric for covering the opening, the shade fabric having a top end and a bottom end, the shade fabric adapted to move between a fully-open position and a fully-closed position;
a rotatably-mounted roller tube mounted adjacent the top end of the shade fabric;
a support member located between the roller tube and the opening, the top end of the shade fabric fixedly attached to the support member; and
a flexible material windingly received around the roller tube, the flexible material having a first end connected to the roller tube and a second end opposite the first end, the second end of the flexible material connected to the shade fabric adjacent the bottom edge of the shade fabric, the flexible material draped across an edge of the support member and extending from the bottom end of the shade fabric to the roller tube adjacent to a rear surface of the shade fabric;
wherein the second end of the flexible material is adapted to move in an upward direction and in a downward direction as the roller tube is rotated in respective first and second directions, so as to respectively raise and lower the shade fabric.

79. The shade system of claim 78, further comprising:
a plurality of coupling structures for holding the flexible material adjacent to the rear surface of the shade fabric.

80. The shade system of claim 79, wherein the flexible material comprises a flexible sheet.

81. The shade system of claim 80, wherein the edge of the support member across which the flexible sheet is draped is a rounded surface.

82. The shade system of claim 81, wherein the support member comprises a support bar mounted between the roller tube and the opening, the top end of the shade fabric fixedly attached to the support bar, the support bar having a top edge forming the rounded surface across which the flexible sheet is draped.

83. The shade system of claim 82, further comprising:
a mounting structure mounted above the roller tube and the support bar, such that a gap is formed between the mounting structure and the support bar;
wherein the flexible sheet extends from the roller tube to the bottom edge of the shade fabric through the gap formed between the mounting structure and the support bar.

84. The shade system of claim 83, wherein the support bar is mounted below the mounting structure and is connected to the mounting structure via two attachment bars.

85. The shade system of claim 83, further comprising:
a valance fabric attached to the mounting structure and hanging in front of the roller tube.

86. The shade system of claim 81, wherein the support member comprises a flexible sheet opening through which the flexible sheet extends from the roller tube to the bottom edge of the shade fabric, the flexible sheet opening having a lower edge forming the rounded surface across which the flexible sheet is draped.

87. The shade system of claim 86, further comprising:
a mounting structure mounted above the roller tube, the support member connected to the mounting structure, such that the flexible sheet is able to extend through the flexible sheet opening of the support member; and
a valance fabric attached to the mounting structure and hanging in front of the roller tube.

88. The shade system of claim 80, wherein each of the coupling structures is attached to the rear surface of the shade fabric at attachment points that are spaced apart by an offset distance, such that the coupling structures and the shade fabric form openings for receiving the flexible sheet.

89. The shade system of claim 88, wherein each of the coupling structures comprises an elongated rigid external batten extending horizontally across the rear surface of the shade fabric, the flexible sheet slidingly received through the openings formed by the external battens and the shade fabric, each of the coupling structures further comprising two eyelets located at the attachment points of the coupling structure, each of the external battens received through the eyelets, such that the external battens extend for at least the offset distance between the eyelets.

90. The shade system of claim 89, further comprising:
a plurality of internal battens extending horizontally across and sewn into the rear surface of the shade fabric, each of the internal battens located parallel and adjacent to one of the external battens, the flexible sheet slidingly received between the respective internal and external battens.

91. The shade system of claim 89, wherein each of the coupling structures further comprises an additional eyelet located between the other two eyelets, the respective batten received through the additional eyelet for support around the center of the batten, the flexible sheet comprises two parallel sections of flexible material positioned between the eyelets, such that the additional eyelet is located between the two parallel sections of flexible material.

92. The shade system of claim 79, wherein the shade fabric comprises a roman shade fabric and is adapted to form a plurality of horizontal pleats as the shade fabric moves towards the fully-open position.

93. A roman shade system for covering an opening comprising:
a roman shade fabric for covering the opening, the roman shade fabric having a top end and a bottom end, the roman shade fabric adapted to move between a fully-open position and a fully-closed position;
a rotatably-mounted roller tube mounted adjacent the top end of the roman shade fabric;
a support member located between the roller tube and the opening, the top end of the roman shade fabric fixedly attached to the support member; and
at least two lift bands windingly received around the roller tube and arranged parallel to each other, each lift band having a first end connected to the roller tube and a second end opposite the first end, each lift band draped across an edge of the support member and extending from the bottom end of the roman shade fabric to the roller tube adjacent to a rear surface of the roman shade fabric;
wherein the second end of the each lift band is coupled to the shade fabric adjacent the bottom end of the roman shade fabric, such that the bottom end of the shade fabric is adapted to move in an upward direction and in a downward direction as the roller tube is rotated in respective first and second directions, so as to respectively raise and lower the roman shade fabric.

94. The roman shade system of claim 93, wherein the support member comprises a support bar mounted between the roller tube and the opening, the top end of the roman shade fabric fixedly attached to the support bar, the support bar having a top edge forming a rounded surface across which the lift bands is draped.

95. The roman shade system of claim 93, further comprising:
two support members for each of the lift bands, each support member having a respective opening through which the respective lift band extends, each lift band opening having a lower edge across which the respective lift band is draped.

96. The roman shade system of claim 93, further comprising:
a plurality of coupling structures for holding the flexible sheet adjacent to the rear surface of the shade fabric, each of the coupling structures attached to the rear surface of the roman shade fabric at attachment points that are spaced apart by an offset distance, such that the coupling structures and the shade fabric form openings for receiving the flexible sheet.
